(19) United States
(12) Patent Application Publication
(10) Pub. No.: US 2008/0180793 A1
(43) Pub. Date: Jul. 31, 2008

(54) HIGH CONTENT SCREENING SYSTEM WITH LIVE CELL CHAMBER

(75) Inventors: Richard C. Salisbury, Sewickley, PA (US); Robert D. Parks, Pittsburgh, PA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: CELLOMICS, INC., Pittsburgh, PA (US)

(21) Appl. No.: 11/627,862

(22) Filed: Jan. 26, 2007

(51) Int. Cl. G02B 21/00

(52) U.S. Cl. 359/368; 359/391

(57) ABSTRACT

An apparatus for performing live cell analysis includes a stage housing and a chamber assembly. The stage housing includes a cover having a bottom surface. The chamber assembly is movably disposed below and movable relative to the cover of the stage housing and can removably receive a specimen plate holding live cells. The chamber assembly includes a chamber housing having a perimeter wall with an interior surface and an exterior surface extending from an upper end to a spaced apart lower end. The perimeter wall bounds a compartment that passes all the way through the chamber housing from the upper end to the lower end. At least one gas outlet port is formed on the chamber housing so as to be in communication with the compartment of the chamber housing to allow gas to enter the compartment. A light can be mounted to the cover to facilitate high content screening of the live cells using a microscope in bright field mode.

### CROSS-REFERENCE TO RELATED APPLICATIONS

Not applicable.

### BACKGROUND OF THE INVENTION

1. The Field of the Invention

The present invention relates to environmental control devices and methods for live cell analysis. More specifically, the present invention relates to high content screening systems with a live cell chamber.

2. The Relevant Technology

High-content screening (HCS) is a cell-based screening method that yields temporal-spatial dynamics of cell constituents and processes. The information provided by HCS alleviates bottlenecks in the drug discovery process by providing deep biological information. The assays associated with this method use either fixed or live cells. Fixed cells require no environmental conditioning because the biological information has been fixed in time. In contrast, live cells require the regulation of appropriate environmental conditions. The specific needs of a screen determine whether a live cell or fixed cell assay is advantageous. Fixing cells at a number of different time points can be time consuming. Therefore live cells assays save time when the kinetics of a cellular process need to be characterized. Furthermore live cell assays circumvent potential artifacts associated with a cell fixation process.

Various approaches have been used to provide an HCS system using live cells that monitors and maintains appropriate environmental conditions during live cell scanning. For example, in one approach, an environmental chamber has been provided that comprises a chamber housing with a lid that closes after a specimen plate has been inserted into the chamber. A heater is attached to the lid to heat the specimen plate that has been placed within the chamber while a microscope performs scanning of the live cells from underneath the chamber. Although this is an improvement in the art, a number of deficiencies remain.

For example, by having the heater in the lid only, temperature gradients can occur within the specimen plate that can cause live cells that are disposed in different portions of the chamber to be heated to differing temperatures. This can skew the results of the HCS, especially if the cells are to be compared with one another. Another problem is that since heat rises, using the lid alone to heat the chamber is very inefficient. It would be an improvement in the art to realize a more even heat distribution among the cells.

Another problem associated with maintaining a live cell chamber is that current methods do not allow automation in using and maintaining live cells. For example, because current methods typically require loading a specimen plate containing live cells into an enclosed cell chamber and then loading the enclosed cell chamber into a microscope assembly, conventional robots are precluded from carrying out the loading and unloading processes.

Current HCS systems of fixed cells can scan cells using either dark field or bright field illumination. In dark field mode, the light source that illuminates the cells is disposed such that only light that is scattered by particles within the cells can pass through the microscope during scanning. That is, no direct light from the light source passes through the microscope. In bright field mode, by contrast, the light source is located such that light can pass directly through the microscope during scanning. That is, at least some of the light passes through the cells and through the microscope without being scattered by the particles within the cells. Each mode provides unique advantages that the other mode does not. However, many conventional live cell scanners only provide dark field mode when performing HCS of live cells. Thus, none of the advantages of bright field mode can be obtained with these conventional live cell scanning systems.

Accordingly, it would be an improvement in the art to provide a scanning system that solves some or all of the above problems and/or other limitations known in the art.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a perspective view of a scanning system according to one embodiment of the present invention;

FIG. 2 is a front perspective view of an HCS system used in the scanning system shown in FIG. 1 with a chamber assembly retracted into a recess within the HCS system;

FIG. 2A is a cross sectional front view of a compartment of the HCS system shown in FIG. 2 in which the microscope is partially disposed;

FIG. 3 is a top perspective view of the HCS system shown in FIG. 2 with a chamber assembly outwardly extending from a recess within the HCS system;

FIG. 3A is a perspective view of a portion of the cover used in the HCS system shown in FIG. 2 and a bracket assembly used to mount the cover;

FIG. 4 is an exploded bottom perspective view of a cover used in the HCS system shown in FIG. 2;

FIG. 5 is an exploded perspective view of the chamber assembly and specimen plate used in the HCS system shown in FIG. 2;

FIG. 6 is a top perspective view of a plate holder used in the chamber assembly shown in FIG. 5;

FIG. 7 is a partial cross sectional side view of the chamber assembly shown in FIG. 5 in an assembled state with the specimen plate shown in FIG. 5 loaded into the chamber assembly;

FIG. 8 is a partial cross sectional side view of a chamber housing used in the chamber assembly shown in FIG. 5;

FIG. 9 is a bottom perspective view of the chamber housing used in the chamber assembly shown in FIG. 5;

FIG. 10 is a top perspective view of the chamber housing shown in FIG. 9 with coverings and a heater attached thereto;

FIG. 10A is a cross sectional top view of the chamber assembly shown in FIG. 5 in an assembled state with the specimen plate shown in FIG. 5 loaded into the chamber assembly;

FIG. 10B is a side view of a gradient heater used in the chamber assembly shown in FIG. 5;

FIG. 11 is an exploded perspective view of a stage assembly used in the HCS system shown in FIG. 2;

FIG. 12 is a partial cross sectional side view of the stage assembly shown in FIG. 11 in an assembled state with the stage insert shown in FIG. 5 mounted thereon;

FIG. 13 is a top perspective view of the chamber assembly and specimen plate of FIG. 5 assembled and mounted on the stage assembly of FIG. 11, with an optical reader also mounted on the HCS system;

FIG. 14 is a block diagram schematic of the chamber controller shown in FIG. 1 with a gas preparation system and various heaters, showing control and gas flow through the chamber controller;

FIG. 15 is a partial cross sectional side view of the HCS system shown in FIG. 2 during use, looking up from slightly below the stage housing;

FIG. 16 is a side perspective view of a light assembly that can be used in the scanning system of FIG. 2 according to an alternative embodiment;

FIG. 17 is a cross sectional side view of a portion of the light assembly shown in FIG. 16; and

FIG. 18 is a side perspective view of a plug used in the light assembly shown in FIG. 16.

### DETAILED DESCRIPTION OF THE PREFERRED EMBODIMENTS

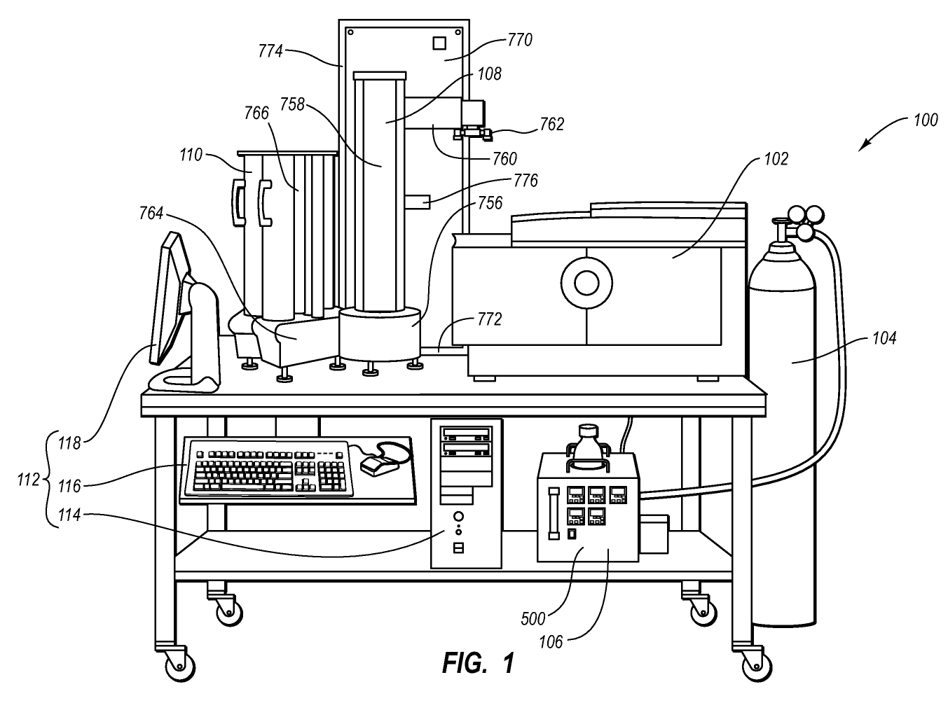

The present invention relates to systems and methods for high content screening of live cells. Depicted in FIG. 1 is one embodiment of a scanning system 100 incorporating features of the present invention. At the heart of scanning system 100 is an HCS system 102 in which cells are scanned and analyzed. As will be discussed below in greater detail, HCS system 102 includes a chamber assembly in which the cells are held during the scanning process. Although the system is discussed below for use in scanning live cells, it is also appreciated that the system can be used for scanning fixed cells.

A number of other devices can also be used with HCS system 102, as shown in FIG. 1. For example, when live cells are used in scanning system 100, means can be provided for keeping the cells alive during the scanning process. Towards this end a pressurized tank 104, such as is known in the art, is included which stores a compressed gas, such as compressed CO₂. The compressed gas is subsequently mixed with ambient air, humidified, heated, and then pumped into HCS system 102, as will be discussed in further detail below. In the embodiment depicted, a chamber controller 106 is included to control the mixing, humidifying, and/or heating of the compressed gas. Chamber controller 106 can also control various heaters and/or be used to house the apparatuses needed for mixing, humidifying, and/or heating the compressed gas. In one embodiment, the compressed gas comprises a gas mixture that is at least 90% CO₂ with 99% CO₂ being more common. Other percentages can also be used.

Another device that can be used with HCS system 102 and thus forming a part of scanning system 100 is a robot 108. Robot 108 can help automate the scanning process by automatically loading and unloading specimen plates containing cells into and out of HCS system 102. By automating the loading and unloading processes, the human element can be removed. This is beneficial because it lessens the chance of error due to human handling of the specimen plates. The chance of contamination is also reduced, especially when using live cells. Another benefit to automation is that more cells can be scanned in a shorter amount of time using robot 108 than by human loading of specimen plates due to the speed and accuracy of robot 108. Robot 108 comprises a base 756 with a rotatable tower 758 extending upward therefrom. Projecting out from tower 758 is an arm 760 that can selectively rise and lower along tower 758. Mounted at the end of arm 760 is a handle 762 that is configured to grasp, carry, and release a specimen plate. It is appreciated that robot 108 can come in a variety of different configurations and need only be designed to carry a specimen plate to and from HCS system 102. One example of robot 108 that can be used is the Twister II made by Caliper Life Sciences Inc. of Mountain View, Calif.

With continuing reference to FIG. 1, a plate rack 110 or an incubator 770 can be used to hold specimen plates containing fixed or live cells, respectively, prior to loading into HCS system 102. Plate rack 110 comprises a base 764 with a housing 766 extending upward therefrom. One or more access points are formed on housing 766 for loading and unloading specimen plates. It is through these access points that handle 762 of robot 108 can retrieve specimen plates to load into HCS system 102. It is appreciated that plate rack 110 can come in a variety of different configurations. Plate rack 110 can be attached to robot 108 or be a stand-alone unit, as is known in the art.

Incubator 770 maintains an environment within it that keeps the cells alive. Incubator 770 comprises a base 772 with a housing 774 extending upward therefrom. One or more slots 776 are formed on housing 774 for loading and unloading specimen plates. Enclosed within housing 774 is a retrieval mechanism that retrieves individual specimen plates disposed within housing 774 and pushes each specimen plate through slot 776 so that handle 762 of robot 108 can retrieve the specimen plate. Also enclosed within housing 774 is a storage mechanism that receives specimen plates from robot 108 through the slot 776 and moves the specimen plates to a storage area within housing 774. It is appreciated that incubator 770 can come in a variety of different configurations. One example of incubator 770 that can be used is Cytomat C10 made by Thermo Fisher Scientific in Langelsbold, Germany.

Robot 108 can be programmed to automatically retrieve an individual specimen plate from plate rack 110 or incubator 770 and load it into HCS system 102. Once the cells on the specimen plate have been scanned, robot 108 can unload the specimen plate from HCS system 102 and return it to plate rack 110 or incubator 770. The process can be subsequently repeated for other specimen plates located within plate rack 110 or incubator 770. Thus, the entire process of loading and unloading specimen plates containing live cells into and out of HCS system 102 can be performed automatically.

Scanning system 100 can also include a system controller 112. System controller 112 comprises a computing device 114, a user input device 116 and a user display device 118. During operation, the user enters input parameters using user input device 116 and views outputs from the system using user display device 118. Computing device 114 takes the user inputs received from user input device 116, outputs control signals to the rest of scanning system 100, receives feedback from scanning system 100, and displays results to the user via user display device 118.

Although user input device 116 is depicted as a computer keyboard and mouse and user display device 118 is depicted as a computer monitor, it is appreciated that other types of input and display devices can alternatively be used. For example, a remote control device can be used as the input device and an LCD screen can be used as the display device. It is also appreciated that input device 116 and user display device 118 can be combined into a single integrated unit, such as a touch screen or the like. Finally, computing device 114, user input device 116 and user display device 118 can alternatively be combined into a single unit, such as a laptop computer.

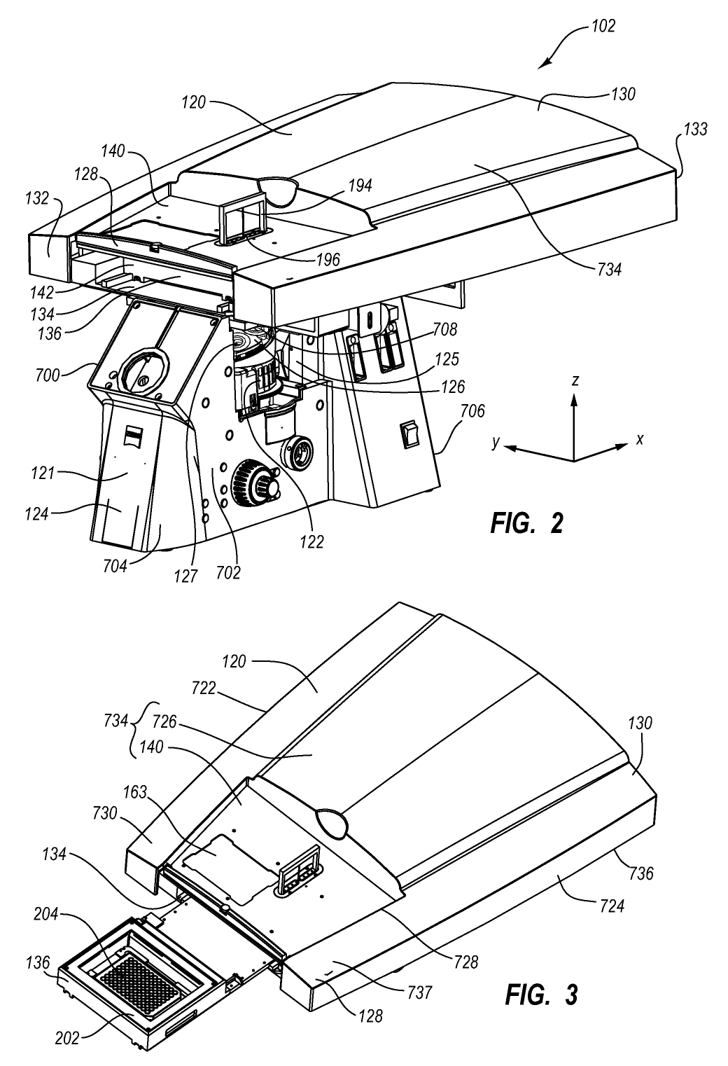

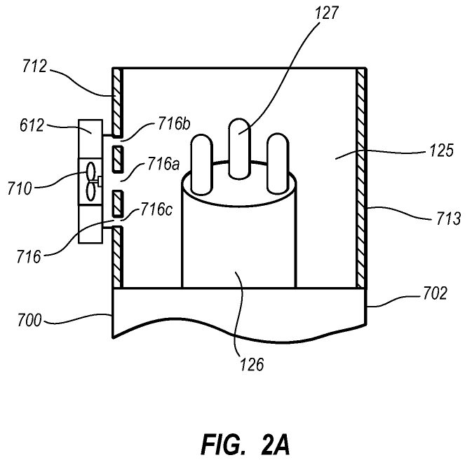

Turning to FIG. 2, HCS system 102 comprises a stage housing 120 mounted on a microscope assembly 121. In general, stage housing 120 is configured to house the components required to position a specimen plate containing live cells so microscope assembly 121 can perform high content screening of the live cells.

Microscope assembly 121 houses an inverted microscope that can be used to perform screening of cells from underneath the cells. Microscope assembly 121 comprises a housing 124 having a first sidewall 700 and a second sidewall 702 that both extend from a proximal end 704 to a spaced apart distal end 706. A compartment 125 extends all the way through housing 124 from first sidewall 700 to second sidewall 702 and is open at a top side 708 of housing 124.

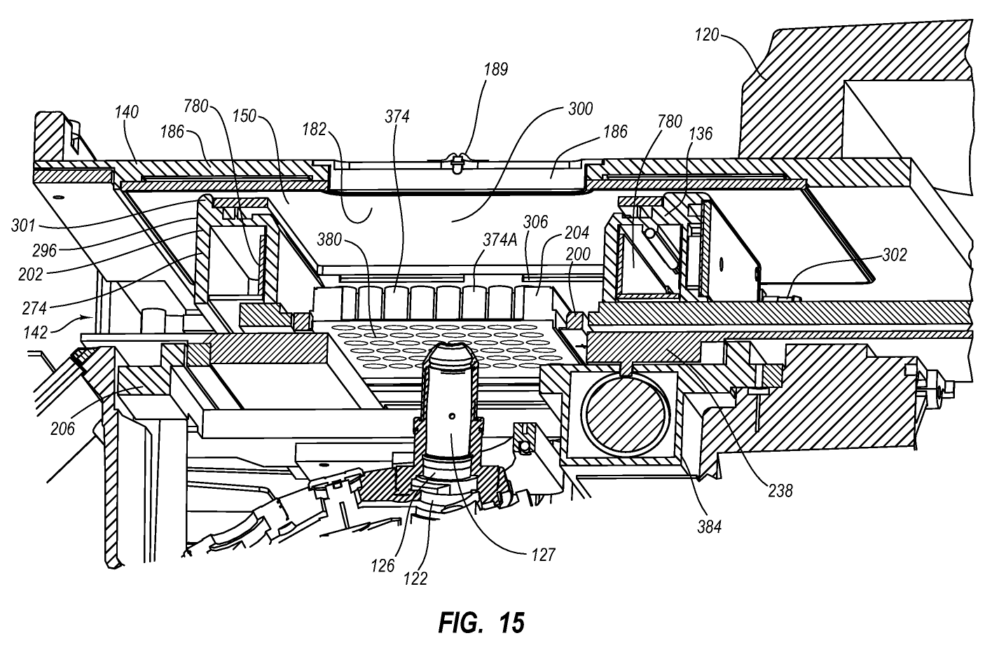

Disposed within housing 124 is an inverted microscope 122 with a lens assembly 126 projecting upward into compartment 125. Lens assembly 126 includes one or more lenses 127 that can be moved up or down (with respect to microscope assembly 121) or rotated by microscope 122 so as to align and focus any one of the lenses 127 on a well 374 of the specimen plate 204 disposed above the lens 127 (see FIG. 15). Many conventional inverted microscopes can be used as microscope 122. For example, microscope Axiovert 200M manufactured by Carl Zeiss MicroImaging, Inc. in Goettingin, Germany can be used in embodiments of the current invention.

Depicted in FIG. 2A is a cross sectional front view of compartment 125. As depicted therein, covers 712 and 713 can be mounted on sidewalls 700 and 702, respectively, so as to cover the opposing openings to compartment 125. Covers 712 and 713 are typically made of a transparent material, such as Plexiglas, but other materials can also be used. Covers 712 and 713 act as partial insulators to help maintain the temperature relatively steady within compartment 125. Covers 712 and 713 are mounted so that compartment 125 is not completely sealed. That is, air or other gases are able to leak into and out of compartment 125 when covers 712 and 713 are mounted in place.

In one embodiment, a heater 612 is disposed within or communicates with compartment 125 to help maintain the live cells at a predetermined temperature by heating the cells from below. Heater 612 can comprise an electrical heater, radiant heater, or the like. In the embodiment depicted, heater 612 is mounted on cover 712 outside of compartment 125.

Heater 612 can include a blower 710, such as a fan or other conventional blower, to circulate the heated air. By circulating the heated air, a more even heating of the cells is achieved. As noted above, this allows for more reliable test results.

One or more holes 716 are formed through cover 712 to facilitate circulation of air from compartment 125 through heater 612 and back into compartment 125. For example, during operation, blower 710 causes air from within compartment 125 to pass through hole 716a and into heater 612. The air becomes heated as it passes through heater 612 and is forced back into compartment 125 through holes 716b and 716c by the same blower 710. It is appreciated that blower 710 and/or heater 612 can alternatively be located within compartment 125.

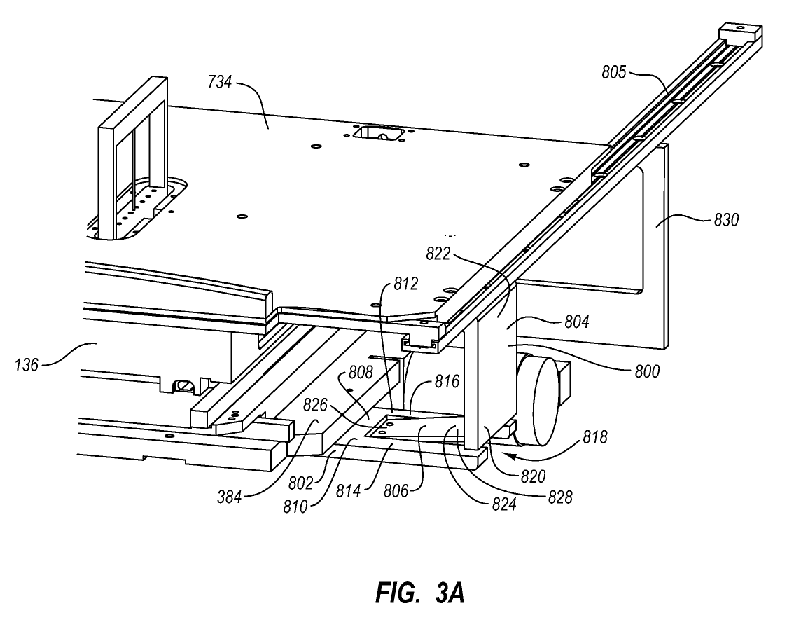

Turning to FIG. 3 in conjunction with FIG. 2, stage housing 120 is mounted on top of microscope assembly 121 so as to cover compartment 125. Stage housing 120 comprises a first sidewall 722, an opposing second sidewall 724, and a top cover 734 extending therebetween, all three of which extend from a proximal end 128 to a spaced apart distal end 130. Top cover 734 comprises a first cover 726 having a substantially U-shaped configuration that covers the distal end 130 and part of the proximal end 128. First cover 726 includes a pair of arms 730 and 732 formed at proximal end 128 that bound an opening 728 therebetween. Top cover 734 also includes a second cover 140 removably disposed in opening 728 and secured to first cover 726.

As depicted in FIG. 2, stage housing 120 further comprises a proximal end face 132 disposed at proximal end 128 and a distal end face 133 disposed at distal end 130. An opening 134 extends through proximal end face 132 and accesses an internal recess 142 at least partially bounded by stage housing 120. Opening 134 is depicted as being substantially rectangular in shape although other configurations can also be used. As will be discussed below in greater detail, a chamber assembly 136 that is adapted to receive and hold a specimen tray, is movably disposed within internal recess 142. Chamber assembly 136 can be selectively moved between an advanced position and a retracted position. In the advanced position, as depicted in FIG. 2, chamber assembly 136 is disposed within internal recess 142 over compartment 125 so as to be covered by top cover 734. In the retracted position, as depicted in FIG. 3, at least a portion of chamber assembly 136 projects out through opening 134 so as to be openly exposed.

As discussed in more detail below, chamber assembly 136 is configured to be moveable with respect to top cover 734 when in the advanced position. To facilitate this, stage housing 120 can include means for resiliently biasing top cover 734 against chamber assembly 136. For example, turning to FIG. 3A, the means for resiliently biasing can comprise one or more bracket assemblies 800 configured to attach top cover 734 to a non-moving portion of stage housing 120 while allowing top cover 734 to be vertically moveable (i.e., in the z direction) with respect to the non-moving portion.

Bracket assembly 800 comprises a first bracket segment 802 mounted to a non-moving portion of stage housing 120 (such as the lower stage base 384, discussed below) and a spaced apart second bracket segment 804 to which top cover 734 directly or indirectly mounts. In the depicted embodiment top cover 734 mounts to a rail 805 which is attached to second bracket segment 804. Bracket assembly 800 further includes a resilient member 806 that connects first bracket segment 802 to second bracket segment 804.

First bracket segment 802 comprises a main body 808 extending from a proximal end 810 to a spaced apart distal end 812. Extending away from main body 808 at the proximal and distal ends 810 and 812 are arms 814 and 816, respectively. Main body 808 and arms 814 and 816 together form a “U” and bound a channel 818 that is open at one end. First bracket segment 802 is configured to lie substantially horizontally when attached to lower stage base 384 with channel 818 facing away from lower stage base 384.

Second bracket segment 804 comprises a plate-like structure extending from a first end 820 to a spaced apart second end 822. Second bracket segment 804 is configured to be positioned substantially orthogonally to first bracket segment 802 and to be movable in the vertical direction with respect to first bracket segment 802. A bend may also be present at second end 822 for ease in mounting top cover 734 or rail 805 to second bracket segment 804.

Resilient member 806 comprises a leaf spring 824 having a first portion 826 mounted to first bracket segment 802 within channel 818 and a second portion 828 mounted to first end 820 of second bracket segment 804. Leaf spring 824 typically has a plate like structure and is used to produce a force in a particular direction. In the depicted embodiment, leaf spring 824 is configured to produce an upward force on second bracket segment 804 while allowing second bracket segment 804 to move vertically. By doing so, leaf spring 824 at least partially counters the weight of top cover 734 when top cover 734 is directly or indirectly mounted to second bracket segment 804. As will be discussed below in greater detail, when chamber assembly 139 is inserted into internal recess 142, top cover 734 rests on top of chamber assembly 139 with the resilient gravitational force pushing top cover 734 down onto chamber assembly 139. However, due to spring 824, the resilient force is less than (and in some cases much less than) the weight of top cover 824. By lessening the resilient force, movement of chamber assembly 139 in the x and y directions is more easily facilitated.

In the depicted embodiment, two bracket assemblies 800 are used, one on either lateral side of and toward the proximal end 128 of stage housing 120. Each bracket assembly 800 attaches to a separate rail 805 which each extend toward the distal end 130 of stage housing 120. To provide a stable and relatively horizontal disposition of top cover 734, a stationary bracket 830 is disposed toward the distal end 130 of stage housing 120. Similar to bracket assemblies 800, stationary bracket 830 is connected to a non-movable portion of stage housing 120 and is configured to allow top cover 734 or rail 805 to be attached thereto. In the depicted embodiment, rail 805 connects to stationary bracket 830 at distal end 130 and top cover 734 connects to rail 805. It is appreciated that more or less number of bracket assemblies 800 can be used in other embodiments in place of or in addition to stationary brackets 830. It is also appreciated that instead of utilizing a rail 805, top cover 734 can be attached directly to bracket assemblies 800 and stationary bracket 830.

Other structures can also function as the means for resiliently biasing top cover 734 against chamber assembly 136. For example, instead of a leaf spring 824, other types of springs, such as a coil springs and rubber-like material, can also be used. As another example, instead of using a bracket assembly 800, a resilient material, such as a compressible foam or rubber, can be positioned between chamber assembly 139 and top cover 734. Other alternative designs can also be used.

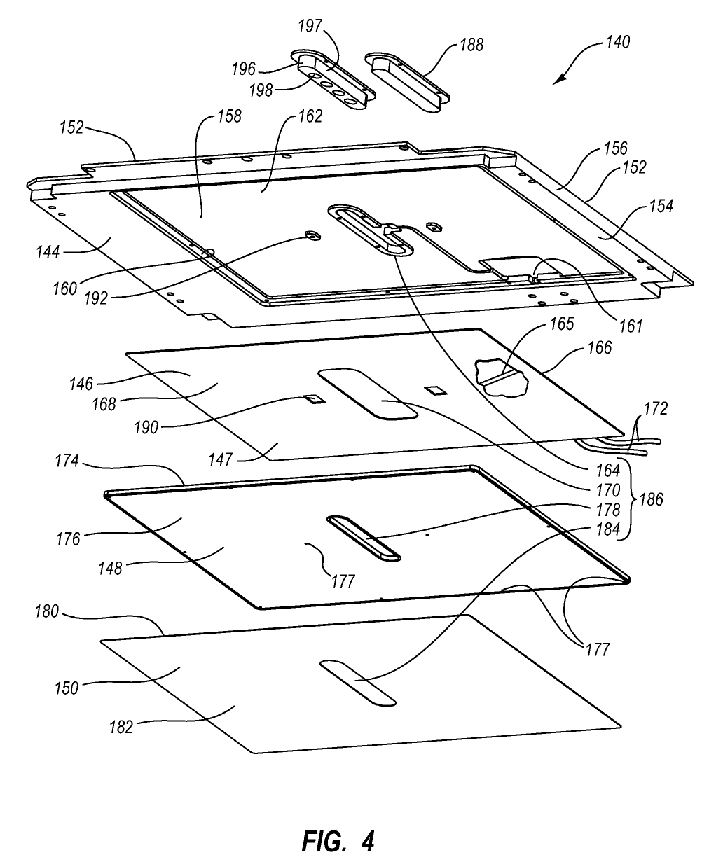

Turning to FIG. 4, second cover 140 comprises a top layer 144, a heater layer 146, a support layer 148, and a bottom layer 150 arranged in that order. Top layer 144 has a top surface 152 and an opposing bottom surface 154 with a perimeter sidewall 156 extending therebetween. A recessed area 158 is formed on bottom surface 154 of top layer 144, bounded by an inner sidewall 160. Sidewall 160 extends from bottom surface 154 to a recessed bottom surface 162. An outlet 161 extends through sidewall 160 for receiving electrical wires as discussed below. Recessed area 158 is sized and shaped to receive the other layers of second cover 140. Also formed within top layer 144 is an aperture 164 that extends completely through top layer 144 between top surface 152 and recessed bottom surface 162. Aperture 164 can be used to aid in pipetting or when bright field illumination is desired. That is, it is through aperture 164 that a pipettor can be inserted or a light can be shined for performing these actions, as described in more detail below. Top layer 144 can also include a recessed area 163 (see FIG. 3) on top surface 152 in which a liquid is held for a pipettor to draw and use for pipetting.

In one embodiment of the present invention, means are provided for heating or controlling the environmental temperature within chamber assembly 136. By way of example and not by limitation, heater layer 146 comprises a body 147 having a top surface 166 and an opposing bottom surface 168, body 147 being sized to be received within recessed area 158 of top layer 144. Body 147 can comprises one or more discrete layers that are flexible or rigid. An aperture 170 extends through body 147 from top surface 166 to bottom surface 168. Aperture 170 is positioned such that aperture 170 is vertically aligned with aperture 164 when heater layer 146 is received within recessed area 158 of top layer 144. An electrical heating element 165 is embedded within or sandwiched between layers of body 147. Electrical wires 172 extend to and from heating element 165 such that when an electrical current is applied to electrical wires 172 and thus heating element 165, heater layer 146 is heated to the desired temperature. Electrical wires 172 extend out through outlet 161 when heater layer 146 is mounted to top layer 144. It is appreciated that a variety of different types of electrical heating element 165 can be used for heating heater layer 146. In yet other embodiments, heater layer 146 can comprise an enlarged electrical heating element.

Support layer 148 is used to secure heater layer 146 to top layer 144. Support layer 148 has a top surface 174 and an opposing bottom surface 176 and is sized to be received within recessed area 158 of top layer 144. An aperture 178 extends through support layer 148 from top surface 174 to bottom surface 176. Aperture 178 is positioned so as to be vertically aligned with aperture 164 when support layer 148 is received within recessed area 158 of top layer 144. Support layer 148 also has a plurality of holes 177 extending therethrough while top layer 144 has holes 192 formed thereon. Fasteners, such as bolts, screws, or the like are passed through holes 177 and secured into holes 192 of top layer 144, thereby securing support layer 148 and heater layer 146 to top layer 150. Other fastening techniques such as welding, adhesive, or clamps can also be used. Apertures 190 can also be formed through heater layer 146 to allow the fasteners to pass therethrough.

With continuing reference to FIG. 4, bottom layer 150 has a top surface 180 and an opposing bottom surface 182 and is sized to be received within recessed area 158 of top layer 144. Top surface 180 of bottom layer 150 is typically mounted on bottom surface 176 of support layer 148 by an adhesive, welding, or other conventional techniques. An aperture 184 is formed within bottom layer 150 that extends completely through bottom layer 150 between top surface 180 and bottom surface 182. Aperture 184 is positioned such that aperture 184 is vertically aligned with aperture 164 when bottom layer 150 is received within recessed area 158 of top layer 144. Bottom layer 150 is positioned and configured so that when chamber assembly 136 is moved from the retracted to advanced position, chamber assembly 136 rides against bottom layer 150.

As will be discussed below in greater detail, in the final advanced position, chamber assembly 136 biases against bottom layer 150 of second cover 140 so as to prevent the flow of gas out of chamber assembly 136 between chamber assembly 136 and bottom layer 150. By preventing gas from leaking out of chamber assembly 136 at this junction, less heat is lost through the top of chamber assembly 136. Furthermore, the gas that enters chamber assembly 136 is forced to travel down through chamber assembly 136 past specimen plate 204, as described in more detail below. This makes for a more efficient and even heating of specimen plate 204 and a more effective gas flow through chamber assembly 136. To enable smooth movement between bottom layer 150 and chamber assembly 136, bottom layer 150 is comprised of a material that has a low coefficient of friction, such as polytetrafluoroethylene (PTFE), commonly sold under the trademark TEFLON. Other types of materials known in the art and having a low coefficient of friction can alternatively be used, such as metals like aluminum. In alternative embodiments, the material for bottom layer 150 can be mounted on the top surface chamber assembly 136 so as to provide smooth movement between chamber assembly 136 and support layer 148.

When second cover 140 is assembled, heater layer 146, support layer 148, and bottom layer 150 are received within recessed area 158 of top layer 144, in that order, such that apertures 164, 170, 178, and 184 are all aligned to collectively form cover aperture 186. When aligned in this fashion, a pipettor (not shown) can be inserted or a light, such as an LED 189 (see FIG. 15) or other type of light can be shined completely through cover aperture 186. A cap 188 can be removably received within cover aperture 186 to plug up cover aperture 186 when cover aperture 186 is not being used. Cap 188 is sized and shaped to snugly fit within cover aperture 186.

Stage housing 120 is mounted over microscope assembly 121 such that cover aperture 186 formed in second cover 140 is vertically aligned with lens assembly 126 of microscope 122 (see FIG. 15). One purpose for this is to allow bright field mode scanning to be performed, as discussed below.

Furthermore, a pipettor (not shown) can be inserted through cover aperture 186. A pipettor guide 196 can be inserted into cover aperture 186. As depicted in FIG. 4, pipettor guide 196 comprises a cap 197, similar to cap 188, that is configured to be received and secured within cover aperture 186. A plurality of holes 198 extend through cap 197. Returning to FIG. 2, a pipettor mount 194 is secured to pipettor guide 196. Pipettor mount 194 is used to guide one or more pipettors through holes 198 in guide 196 so as to direct the pipettors to the cells positioned within chamber assembly 136. In turn, the pipettors can be used to inject material to the cells that are being scanned or to remove material from the cells, as is known in the art.

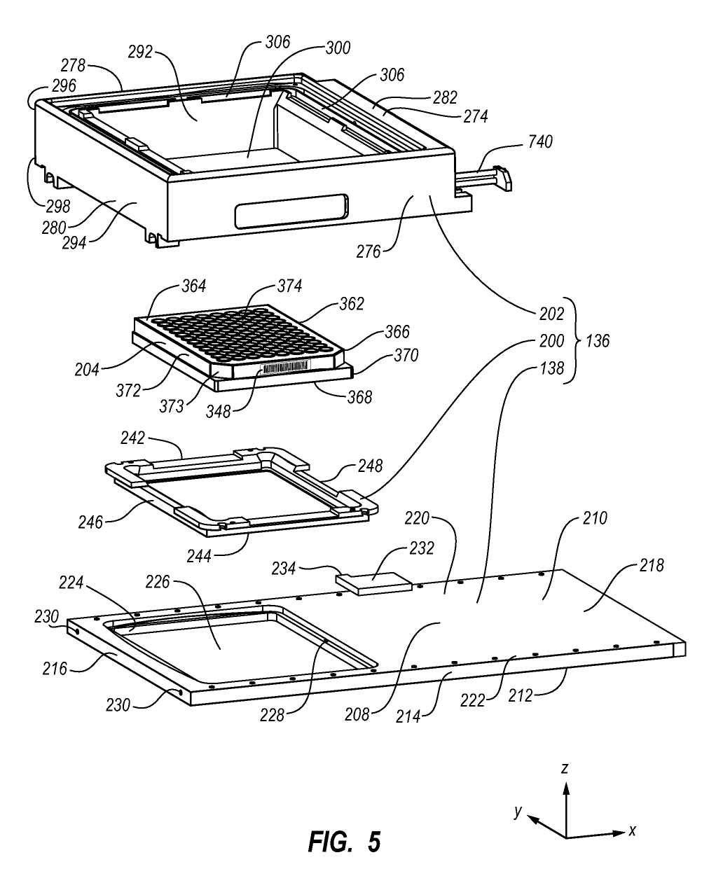

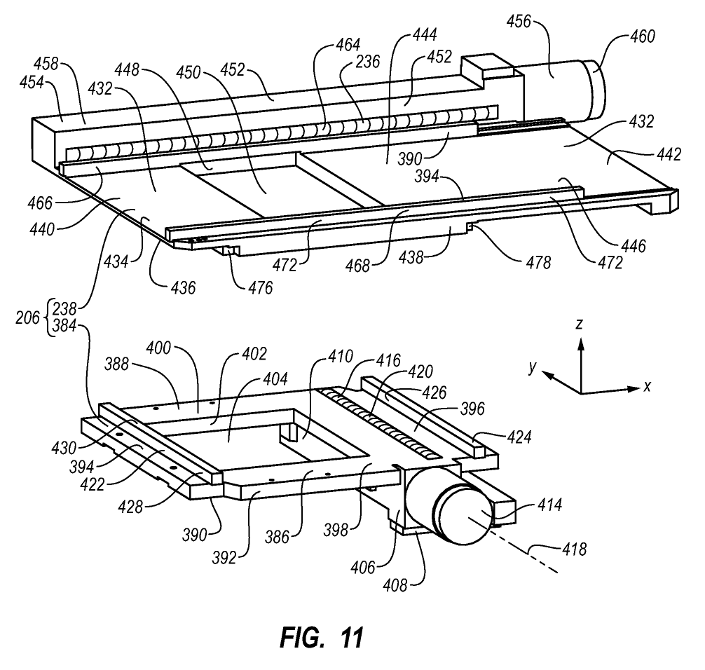

Turning to FIG. 5, chamber assembly 136 comprises a stage insert 138, a plate holder 200 mounted to stage insert 138, and a chamber housing 202 also mounted to stage insert 138. When assembled, chamber assembly 136 is configured to receive a specimen plate 204 holding live cells. Chamber assembly 136 is also adapted to be mounted on a stage assembly 206 (see FIG. 11) that can move chamber assembly 136 two-dimensionally (the x and y directions as shown in FIG. 5) while chamber assembly 136 is disposed under second cover 140 of stage housing 120. Throughout the document, reference is made to x and y directions. As shown in FIG. 2, the x direction is defined as the horizontal direction in which chamber assembly 136 is inserted into and extracted from recess 142, and the y direction is defined as the horizontal direction that is orthogonal to the x direction. The x direction can also be referred to as the proximal and distal direction and the y direction can also be referred to as the lateral direction.

Stage insert 138 comprises a main body 208, typically in the form of an elongated plate, having a top surface 210 and an opposing bottom surface 212 with a perimeter sidewall 214 extending therebetween. Main body 208 extends between a proximal end 216 and an opposing distal end 218, and between a first lateral side 220 and a second lateral side 222. Main body 208 also has an interior sidewall 224 that bounds an opening 226 extending all the way through main body 208 from top surface 210 to bottom surface 212 at proximal end 216. A shoulder 228 that extends into opening 226 is formed on interior sidewall 224. Opening 226 is sized to receive plate holder 200 without allowing plate holder 200 to pass completely through opening 226. Disposed on opposite sides of perimeter sidewall 214 at proximal end 216 of main body 208 is a pair of apertures 230 configured to receive tightening screws. Main body 208 may also include one or more holes configured to receive screws or other securing devices.

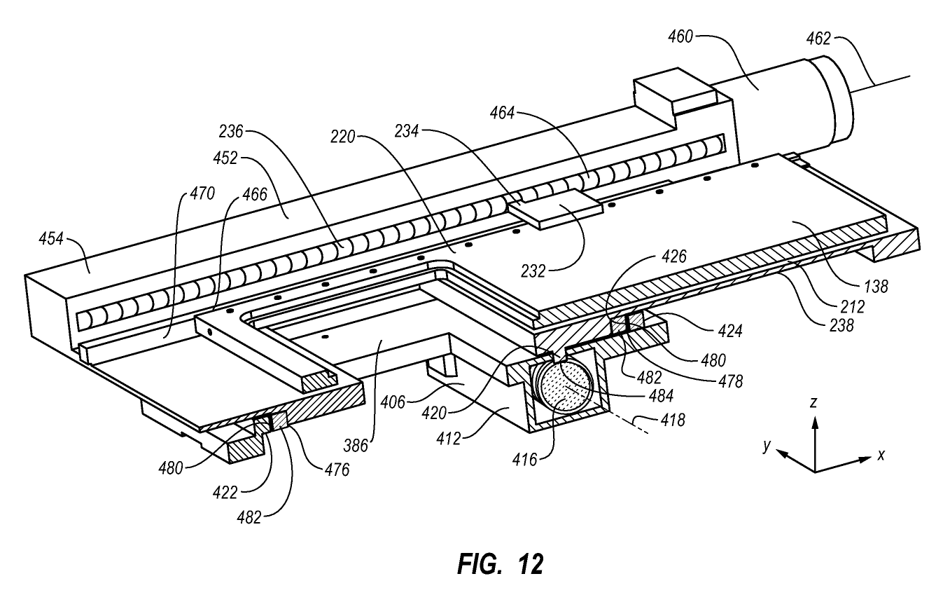

Stage insert 138 also includes an engaging member 232 having a projection 234 extending therefrom to aid in selectively moving stage insert 138 in the x direction. Engaging member 232 is mounted to top surface 210 such that projection 234 extends laterally in the y direction out over first lateral side 220. During use, projection 234 is engaged by a screw drive 236 (see FIG. 12) of an upper stage base 238 to move stage insert 138 in the x direction, as described in more detail below.

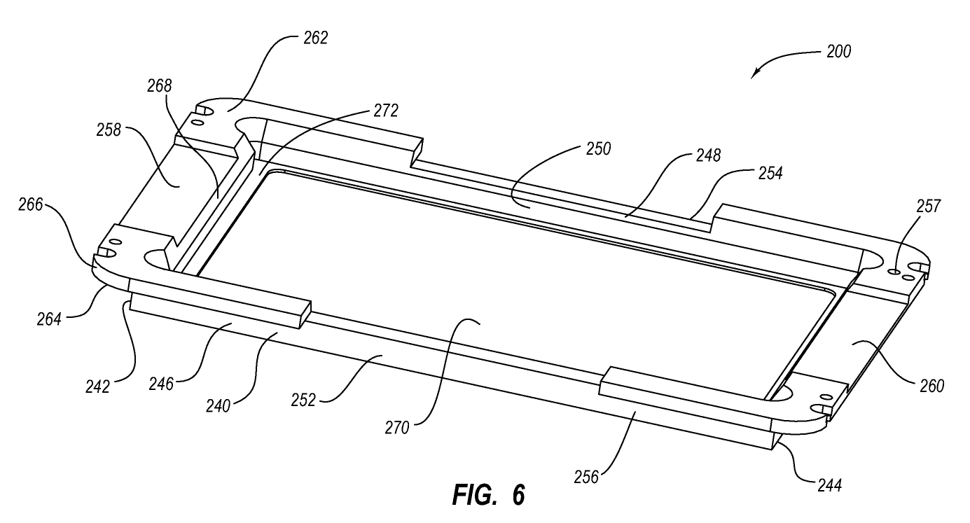

Plate holder 200 is configured to be received within stage insert 138 and to removably receive and position specimen plate 204 holding live cells for live cell scanning. As shown in FIG. 6, plate holder 200 has a perimeter wall 240 comprising four separate wall segments that generally form a rectangle when looked at from above. Alternatively, the four segments can form a square or other polygonal configuration. Lateral wall segments 242 and 244 each extend between a proximal wall segment 246 and a distal wall segment 248 to form perimeter wall 240. Perimeter wall 240 has an interior surface 250 and an opposing exterior surface 252 that extend from an upper end 254 to a spaced apart lower end 256.

As noted above, plate holder 200 is configured to be mounted onto stage insert 138. Toward this end, a pair of outwardly extending lips 258 and 260 are disposed on upper end 254 of plate holder 200 on opposite sides of plate holder 200. Lip 258 is disposed on upper end 254 of lateral wall segment 242 while lip 260 is disposed on upper end 254 of lateral wall segment 244. Except for being disposed on opposite wall segments, the structure of lips 258 and 260 are substantially identical, so only the structure of lip 258 will be discussed. It is appreciated that the discussion of the structure of lip 258 also applies to lip 260.

Lip 258 has an upper surface 262 and an opposing lower surface 264 which extend out over exterior surface 252 in a substantially orthogonal direction to an outer edge 266. Lip 258 extends along the entire length of lateral wall segment 242 and wraps around so as to also be disposed and extend out from a portion of proximal wall segment 246 and distal wall segment 248. Lip 258 has an interior surface 268 that is tapers inward from upper surface 262 to interior surface 250 of perimeter wall 240. The tapering of interior surface 268 helps facilitate automatic centering and placement of specimen plate 204.

Interior surface 250 of perimeter wall 240 and interior surface 268 of lips 258 and 260 together bound a compartment 270 that passes all the way through plate holder 200 from upper end 254 to lower end 256. One or more mounting holes 259 extend through lips 258 and/or 260. Mounting holes 259 can be used to secure plate holder 200 to stage insert 138 by fasteners such as bolts, screws, or the like. It is appreciated that lips 258 and 260 can alternatively be connected with each other so as to form one continuous lip extending completely around plate holder 200. Alternatively, more than two lips can be used.

As noted above, plate holder 200 is configured to removably receive, hold, and position specimen plate 204. Towards this end, an inwardly extending lip 272 is disposed on lower end 256 of interior surface 250 so as to at least partially encircle compartment 270. Lip 272 extends away from interior surface 250 into compartment 270 and is sized to allow specimen plate 204 to rest on lip 272 when specimen plate 204 is disposed within chamber assembly 136.

Turning to FIG. 7 in conjunction with FIG. 6, when chamber assembly 136 is assembled, plate holder 200 is received into opening 226 of stage insert 138 such that lower surfaces 264 of lips 258 and 260 rest on shoulder 228 of interior sidewall 224 of stage insert 138. In this assembled state, compartment 270 of plate holder 200 is aligned with opening 226 of stage insert 138. Although not required, stage insert 138 can be secured to plate holder 200 using fasteners, as discussed above, or by welding, adhesive or other conventional techniques. In yet other embodiments, stage insert 138 and plate holder 200 can be integrally formed from a single piece of material.

Returning to FIG. 5, specimen plate 204 comprises a main body 362 having a top surface 364 at a top end 366 and an opposing bottom surface 368 at a bottom end 370 with a perimeter sidewall 372 extending therebetween. In one embodiment, one or more angled portions 373 are formed by perimeter sidewall 372 which are angled in the x and y directions so as to face away from main body 362. These angled portions 373 can be used to help register specimen plate 204, as discussed in more detail below. A plurality of wells 374 is formed in top surface 364 of main body 362. These wells are adapted to receive live cells and their associated media.

Returning to FIG. 7 in conjunction with FIG. 5, each well 374 comprises a perimeter wall 376 bounding a cylindrical bore 378 that extends from top end 366 to bottom end 370. A bottom wall 380 is located in each bore 378 at or near bottom end 370. In one embodiment, each bottom wall 380 forms a portion of bottom surface 368 of specimen plate 204. Specimen plate 204, or at least bottom walls 380, are made of a material that is sufficiently transparent to enable microscope 122 to scan or screen of cells through bottom wall 380 of each well 374. In one embodiment specimen plate 204 and/or bottom walls 380 can be made of a transparent glass or plastic.

As noted above, specimen plate 204 is configured to be removably received on plate holder 200. To facilitate this, perimeter sidewall 372 of specimen plate 204 is sized to fit within compartment 270 of plate holder 200 so that specimen plate 204 rests on lip 272 of plate holder 200 (FIG. 7) while allowing gas to flow between specimen plate 204 and lip 272. Specifically, in the depicted embodiment a portion 382 of perimeter sidewall 372 extends down and away from specimen plate 204 at bottom end 370 so as to rest on lip 272 of plate holder 200 when specimen plate 204 is received within plate holder 200. The junction between specimen plate 204 and lip 272 is configured to allow gas to flow therebetween when the gas is under a positive pressure.

In some embodiments, means for identifying specimen plate 204 can also be embedded within or attached to specimen plate 204. For example, in the depicted embodiment an optical identifier 348 is mounted on sidewall 372 for identifying the discrete specimen plate and the cells positioned thereon. Optical identifier 348 can take the form of a bar code, an optical ID tag, or other type of optical identifier as is known in the art. Other types of means for identifying can alternatively be used. For example, electronic identifiers can be embedded within or attached to specimen plate 204, such as an electronic ID chips, or the like.

Returning to FIG. 5, chamber housing 202 has a perimeter wall 274 comprised of four separate wall segments that generally form a rectangle when looked at from above. Lateral wall segments 276 and 278 each extend between a proximal wall segment 280 and a distal wall segment 282 to form perimeter wall 274. Chamber housing 202 is configured such that proximal wall segment 280 is nearest opening 134 of stage housing 120 when chamber assembly 136 has been advanced into recess 142, as shown in FIG. 2. It is appreciated that other shapes can also be formed by perimeter wall 274.

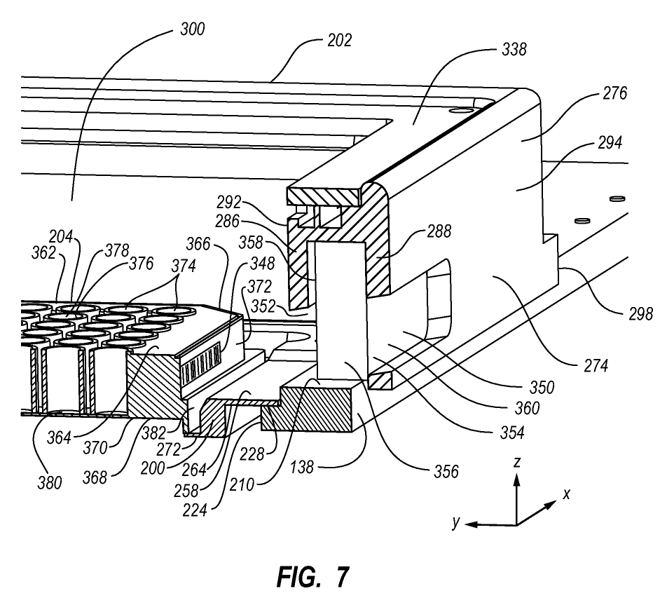

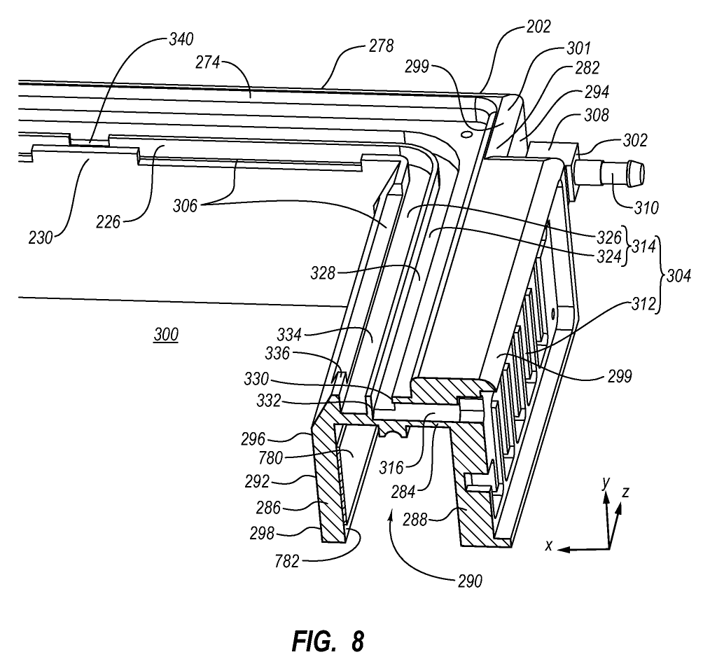

Turning to FIG. 8 in conjunction with FIG. 5, in one embodiment perimeter wall 274 has a top wall 284 with an inner sidewall 286 and a spaced apart outer sidewall 288 that extend downward from top wall 284 along opposing sides thereof. Top wall 284 and sidewalls 286 and 288 bound a channel 290 that extends along at least a portion of a length of perimeter wall 274. In one embodiment, channel 290 extends along the entire length of perimeter wall 274. In other embodiments, perimeter wall 274 is solid, having no channels formed therein. In still other embodiments, a combination of solid wall segments and channeled wall segments are used.

In any event, perimeter wall 274 has an interior surface 292 and an opposing exterior surface 294 that extend from an upper end 296 to a spaced apart lower end 298. In the depicted embodiment, interior surface 292 and exterior surface 294 are disposed on inner sidewall 286 and outer sidewall 288, respectively, and face away from each other. Interior surface 292 of perimeter wall 274 bounds a compartment 300 that passes all the way through chamber housing 202 from upper end 296 to lower end 298.

In one embodiment, a compressible member 301 is disposed on perimeter wall at the upper end 296 of chamber housing 202. Compressible member 301 is used to help form a seal with cover 18 when chamber housing is used in HCS system 102. Compressible member 301 is an example of another type of means for producing a resilient force, as noted above.

With continuing reference to FIG. 8, to keep the cells alive during the scanning process, chamber assembly 136 provides gas means for providing a continuous flow of a cell-sustaining gas through chamber assembly 136. The content of the cell-sustaining gas depends in part on the type of cells being grown and typically comprises air mixed with a low concentration of CO₂. The CO₂ can be used to help monitor and control the pH of the media in which the cells are grown as is known to those skilled in the art. Other gas can also be added. The gas means comprises a gas inlet port 302 disposed on exterior surface 294 of perimeter wall 274, a gas pathway 304 disposed within or attached to perimeter wall 274, and one or more gas outlet ports 306 disposed on interior surface 292 of perimeter wall 274. Gas inlet port 302, gas pathway 304, and gas outlet ports 306 fluidly communicate with each other such that a gas that is inputted into gas inlet port 302 flows through gas pathway 304 and exits into compartment 300 through gas outlet ports 306.

Gas inlet port 302 comprises a body 308 attached to exterior surface 294 with a tubular coupling 310 extending from body 308. Coupling 310 is configured to couple with a conventional hose or equivalent. Coupling 310 can comprise a tubular stem having an annular barb formed on the end thereof. Other conventional gas couplings can also be used.

Gas pathway 304 is a channel or conduit configured to receive gas from gas inlet port 302 and pass the gas through to gas outlet ports 306. As depicted, gas pathway 304 comprises a first pathway 312 and a second pathway 314 fluidly connected via a passageway 316. First pathway 312 is embedded within or attached to exterior surface 294 of perimeter wall 274 and is configured to fluidly communicate with gas inlet port 302. In one embodiment, at least a portion of first pathway 312 has a zigzag or sinusoidal pattern, as shown in FIG. 9, that extends along a length of perimeter wall 274. It is appreciated that the zigzag pattern can have a variety of different configurations. In one embodiment the zigzag pattern comprises a plurality of turns which is typically at least 5, at least 10, at least 15 or at least 20 turns. Other numbers can also be used. Although not required, the turns are often formed on a common plane and are the same repeating size and shape. The use of the zigzag pattern slows down the linear movement of the gas so that it can be heated to a desired temperature prior to entering compartment 300. Heating of the gas will be discussed below in greater detail.

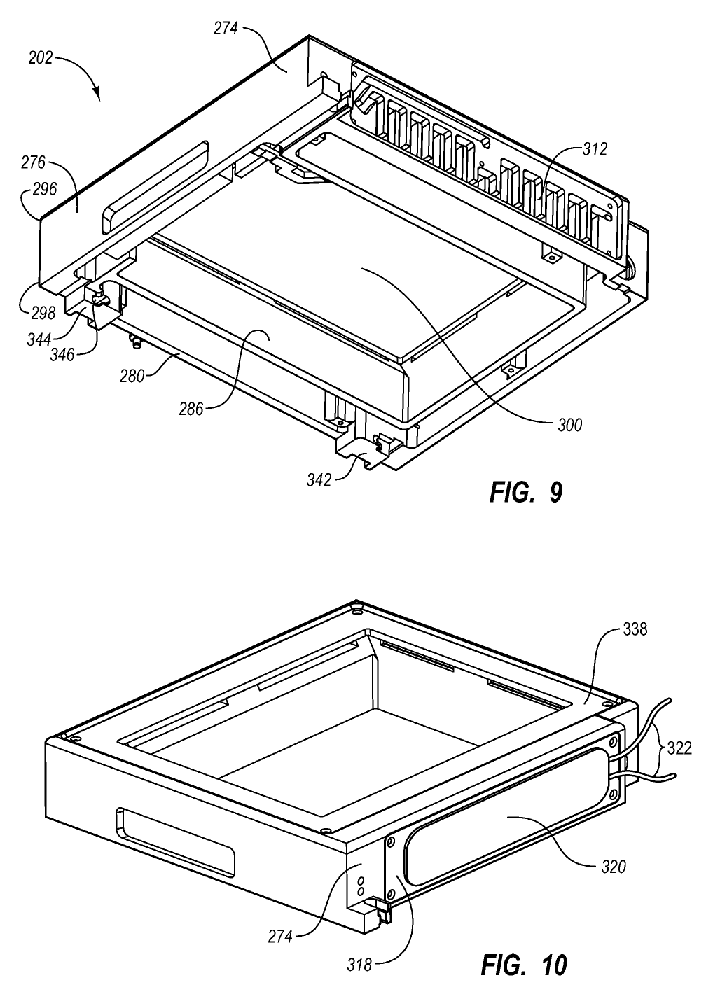

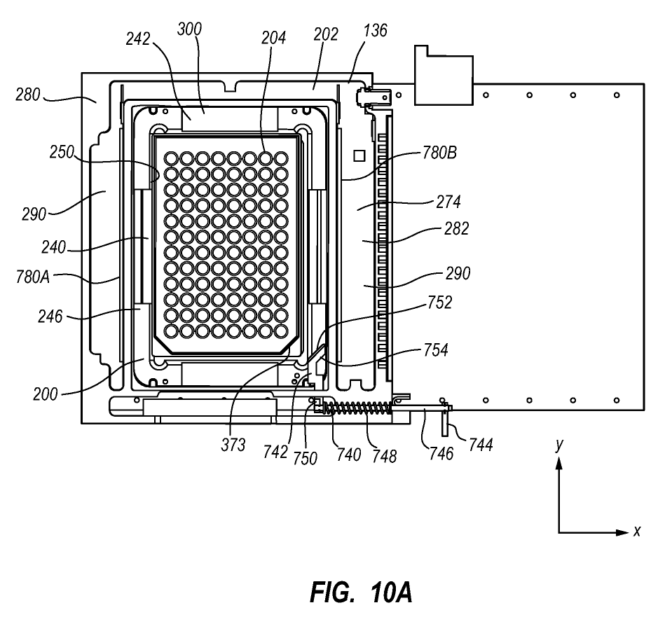

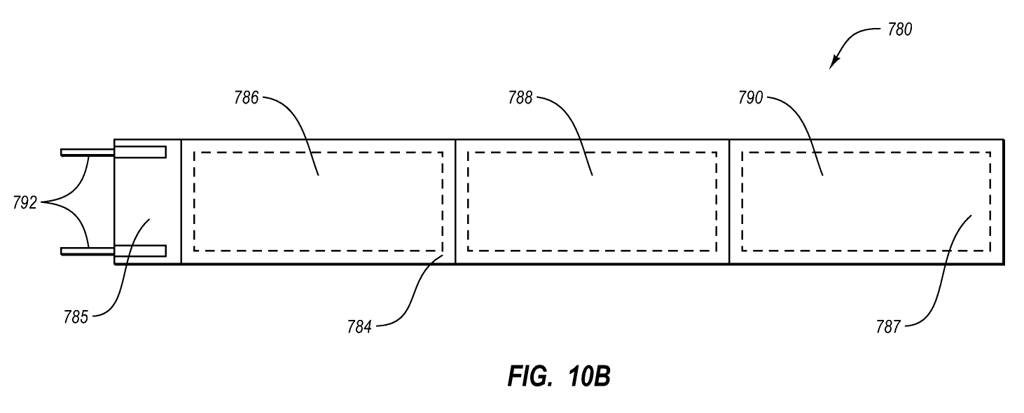

As depicted in FIG. 10, a covering 318 is mounted on perimeter wall 274 so as to enclose first pathway 312. Covering 318 can be attached to perimeter wall 274 using screws, adhesive, or other fastening techniques known in the art. As noted above, the gas that is passed through first pathway 312 can be heated to a desired temperature before entering compartment 300. Towards this end, a heating element 320 can be attached to covering 318 so as to heat covering 318 which in turn heats the gas. In one embodiment heating element 320 can be electrical. One or more wires 322 are thus attached to heating element 320 and extend to an external power source (not shown) to provide power to energize heating element 320. Other means for heating, such as heated liquid or gas, can also be used.

Returning to FIG. 8 in conjunction with FIG. 5, second pathway 314 is disposed on or in top wall 284 of perimeter wall 274 and is configured to receive the gas after the gas has flowed through first pathway 312. Second pathway 314 is designed to distribute the gas received from first pathway 312 around perimeter wall 274 so as to make the gas available to gas outlet ports 306. In one embodiment, second pathway 314 comprises one or more enclosed channels formed on top wall 284.

For example, in the embodiment depicted, second pathway 314 comprises an outer channel 324 and an adjacent inner channel 326. Outer channel 324 has a floor 328 with opposing sidewalls 330 and 332 that extend upward from floor 328 along opposing sides thereof. Inner channel 326 is formed adjacent to outer channel 324 such that sidewall 332 is shared between channels 324 and 326. That is, similar to outer channel 324, inner channel 326 also has a floor 334 with a sidewall 336 and shared sidewall 332 that extend upward from floor 334 along opposing sides thereof. Similar to first pathway 312, a covering 338 (see FIG. 10) is placed thereon to enclose second pathway 314. Covering 338 can be attached to top wall 284 using screws, adhesive, or other fastening techniques known in the art.

To facilitate the flow of gas between outer channel 324 and inner channel 326, one or more passageways 340 are formed through shared sidewall 332 so as to allow fluid communication between channels 324 and 326. As a result, the gas from first pathway 312 enters outer channel 324, flows around perimeter wall 274 in outer channel 324, then flows through passageway 340 into inner channel 328.

The one or more gas outlet ports 306 extend from interior surface 292 of perimeter wall 274 to inner channel 326. In the depicted embodiment, gas outlet ports 306 comprise two elongated ports that are formed on each perimeter wall segment 276-282 at upper end 296. Although not required, these outlet ports can extend over at least 50% of the length of each wall segment. This placement and formation of the gas outlet ports 306 helps produce a uniform distribution of gas within compartment 300 to help optimize cell viability. Although a plurality of gas outlet ports 306 is depicted, it is appreciated that a single or two or more outlet ports 306 can alternatively be used. It is also appreciated that gas outlet ports 306 can alternatively be formed at lower end 298 of interior surface 292 of perimeter wall 274 or any location between upper end 296 and lower end 298.

Continuing with FIG. 8, in addition to heating of the air/CO₂ gas mixture before it is used within HCS system 102, other means for heating can be used within HCS system 102 to maintain the live cells at a predetermined temperature. For example in some embodiments, various heaters are disposed on or around chamber assembly 136. In the depicted embodiment, heaters 780 are mounted onto a surface 782 of one or more sidewalls 286 that is opposite interior surface 292. In this manner, heaters 780 are disposed within channel 290.

As noted above, it is desired to maintain all of the cells at substantially the same predetermined temperature to obtain more reliable results. In one embodiment, the heaters disposed on or around chamber assembly 136 comprise gradient heaters 780 configured to maintain an even temperature among all of the cells.

Turning to FIG. 10B, gradient heater 780 comprises an electrical heating element 784 extending between a proximal end 785 and a spaced apart distal end 787. Heating element 784 is divided into multiple heating zones that provide different amounts of heat based upon the location of the particular zone in the heating element. For example, in the depicted embodiment, heating element 780 is divided into three separate heating zones 786, 788, and 790. Heating zones 786 and 790 are disposed at the proximal end 785 and distal end 787 of heating element 784, respectively, and heating zone 788 is disposed between heating zones 786 and 790. Each zone is configured to provide a predetermined amount of heat when energized. One or more wires 792 are attached to proximal end 785 of heating element 780 and extend to an external power source (not shown) to provide power to energize heating zones 786, 788, and 790. Gradient heaters 780 can be attached by adhesive or other method known in the art.

Gradient heater 780 can run the entire length of channel 290 or can be disposed along a shorter portion of channel 290. Also, separate gradient heaters 780 can be disposed within one, two, three or all wall segments of perimeter wall 274. In the embodiment shown in FIG. 10A, gradient heaters 780A and 780B are disposed within proximal wall segment 280 and distal wall segment 282, respectively, with lateral wall segments 276 and 278 having no heaters. One reason for doing this is to accommodate an optical identifier that can be read by a corresponding optical reader through a window in one of the lateral walls 276 or 278, as described below.

In the depicted embodiment, each gradient heater 780 is configured to provide a greater amount of heat to the sides of specimen plate 204 that are disposed against lateral wall segments 276 and 278 to compensate for those wall segments not having corresponding heaters. To facilitate this, heating zones 786 and 790 are configured to produce more heat than heating zone 788 when gradient heater 780 is energized. In this manner, the heat is more evenly distributed across all of the cells disposed in specimen plate 204. In alternative embodiments, uniform heaters can be positioned along each of the four wall segments.

Returning to FIG. 9 in conjunction with FIG. 5, a pair of attaching members 342 and 344 is disposed at lower end 298 of opposing ends of proximal wall segment 280. Each attaching member 342 and 344 bounds a passageway 346 that extends all the way through the attaching member. Attaching members 342 and 344 are each configured to allow a fastener, such as a screw, bolt, or other fastening device, to pass through passageway 346 for securing chamber housing 202 to stage insert 138.

Turning to FIG. 10A, in one embodiment a registration mechanism 740 is included within chamber assembly 136 to help position specimen plate 204. Registration mechanism 740 comprises a biasing member 742 and a spaced apart end plate 744 with an elongated connecting member 746, such as one or more rods, extending therebetween. Registration mechanism further includes a spring 748 attached to connecting member 746 at one end of spring 748. Biasing member 742 extends from a proximal end 750, which is attached to connecting member 746, to an end face 752 formed on a spaced apart distal end 754. End face 752 is generally parallel to the z direction, but angled in the x and y direction so as to face away from connecting member 746. End face 752 is angled to bias against a corresponding angled portion 373 of perimeter sidewall 372 of specimen plate 204 when specimen plate 204 has been inserted into chamber assembly 136.

When assembled within chamber assembly 136, registration mechanism 740 is positioned such that biasing member 742 is disposed within compartment 300 and end plate 744 is disposed exterior to perimeter wall 274 with connecting member 746 extending through perimeter wall 274. The end of spring 748 not attached to connecting member 746 is attached to perimeter wall 240 so that the spring can compress or stretch when connecting member 746 is moved along its longitudinal axis. Registration mechanism 740 is configured to be able to move from an original retracted position to a biasing position and back.

Registration mechanism 740 is configured so that when no force is applied to end plate 744, registration mechanism 740 is in the retracted position shown in FIG. 10A. In this retracted position, biasing member 742 is disposed away from specimen plate 204 and end plate 744 is positioned away from perimeter wall 274. In this configuration, specimen plate 204 can be loaded and unloaded from chamber assembly 136.

To move from the retracted to the biasing position, end plate 744 is pushed in the x direction toward perimeter wall 274, which causes biasing member 742 to correspondingly move in the x direction toward specimen plate 204. At a certain point, end face 752 biases against the angled portion 373 of sidewall 372 of specimen plate 204. Because biasing member 742 and portion 373 are both angled in a matching manner, as end plate 744 is further pushed, biasing member 742 pushes specimen plate 204 in a direction away from end face 752 in both the x and y directions. This causes specimen plate 204 to register, or securely seat against the interior surface 250 of the proximal wall segment 246 and lateral wall segment 242 of perimeter wall 240 of plate holder 200. Specimen plate 204 remains registered until the force that is pushing on end plate 744 is removed or diminished. When registration mechanism 740 is in this biased position, specimen plate 204 can be scanned or otherwise used and cannot be unloaded from chamber assembly 136.

To move registration mechanism 740 back to the retracted position, the force pushing on end plate 744 is removed or diminished. Spring 748 is attached so that it will push connecting member 746 away from specimen plate 204 in the x direction when no contravening forces are applied to registration mechanism 740. In one embodiment, a pushing force is applied to end plate 744 by the stage housing when chamber assembly 136 is retracted into recess 142, as described below.

Returning to FIG. 7 in conjunction with FIG. 5, scanning system 100 can also be designed to give the user the ability to read an optical identifier 348 or other identifier attached to specimen plate 204 while specimen plate 204 is disposed within chamber assembly 136. To facilitate this, perimeter wall 274 of chamber housing 202 includes an opening 350 that extends completely through perimeter wall 274 between interior surface 292 and exterior surface 294 so as to communicate with compartment 300. In the depicted embodiment, opening 350 is disposed on wall segment 276. If, as in the depicted embodiment, wall segment 276 is comprised of an inner sidewall 286 and an outer sidewall 288, then corresponding apertures 352 and 354 are formed in sidewalls 286 and 288, respectively, that together form opening 350. Opening 350 is generally rectangular in shape when viewed from outside perimeter wall segment 276, but other shapes are also possible.

In the depicted embodiment, aperture 352 is situated further toward lower end 298 of chamber housing 202 than aperture 354 such that opening 350 is angled downward toward compartment 300 as it is viewed in cross section. This is done so that when specimen plate 204 is received within plate holder 200 and plate holder is situated towards the lower end 298 of chamber housing 202, optical identifier 348 attached to specimen plate 204 can be read from outside chamber housing 202 through opening 350.

With continuing reference to FIG. 7, to prevent gas from escaping compartment 300, a transparent window 356 is disposed within opening 350. Window 356 is transparent so that optical identifier 348 can be read through window 356. In the depicted embodiment, transparent window 356 has an inside surface 358 and a spaced apart outside surface 360. Window 356 is disposed between inner sidewall 286 and outer sidewall 288 such that inside surface 358 is adjacent to or biased against inner sidewall 286 and outside surface 360 is adjacent to or biased against outer sidewall 288 around apertures 352 and 354. Window 356 can be made of glass, acrylic, plastic, or any other transparent material that will allow optical identifier 348 to be read through the material.

During assembly, chamber housing 202 is mounted to stage insert 138 such that lower end 298 of perimeter wall 274 biases against top surface 210 of stage insert 138 around the perimeter of perimeter wall 274. Once chamber housing 202 has been mounted to stage insert 138, fasteners are passed through passageways 346 of attaching members 342 and 344 (FIG. 9) and screwed into apertures 230 of stage insert 138 (FIG. 5) to secure chamber housing 202 to stage insert 138. In this assembled state, compartment 300 of chamber housing 202 is aligned with compartment 270 of plate holder 200.

Turning to FIG. 11, stage assembly 206 is provided to move chamber assembly 136 in the x direction (i.e. proximally/distally) as well as in the y direction (i.e. laterally) while chamber assembly 136 is disposed under second cover 140 of stage housing 120. Stage assembly 206 comprises a lower stage base 384 with upper stage base 238 movably mounted thereon.

Lower stage base 384 comprises a main body 386 having an elongated plate like configuration with a top surface 388, an opposing bottom surface 390, and a perimeter sidewall 392 extending therebetween. Main body 386 extends between a proximal end 394 and a spaced apart distal end 396, and between a first lateral side 398 and a second lateral side 400. Main body 386 also has an interior sidewall 402 that bounds an opening 404 extending all the way through main body 386 from top surface 388 to bottom surface 390.

Extending along distal end 396 of lower stage base 384 is a lower screw drive assembly 406 that extends between a first end 408 and a spaced apart second end 410 and projects downward, away from bottom surface 390. Lower screw drive assembly 406 is configured to move chamber assembly 136 in the y direction when chamber assembly 136 is mounted on upper stage base 238. Turning to FIG. 12 in conjunction with FIG. 11, lower screw drive assembly 406 comprises a housing 412 downwardly projecting from bottom surface 390. An elongated opening 420 extends through main body 386 so as to communicate with housing 412 along the length of thereof. An elongated screw drive 416 is rotatably disposed within housing 412. One or more helical threads are formed along the length of screw drive 415 and are openly exposed through opening 420. A motor 414 is mounted on the end on screw drive 416 and facilitates rotation of screw drive 415 about longitudinal axis 418.

Control and data signals are sent between system controller 112 and lower screw drive assembly 406 via one or more wires (not shown). For example, control signals directing motor 414 when to rotate screw drive 416 and in which direction (clockwise or counterclockwise) are sent from system controller 112 to lower screw drive assembly 406. Information concerning the relative location of upper stage base 238 along screw drive 416 is sent from lower screw drive assembly 406 to system controller 112. Other control and data signals can also be sent between system controller 112 and lower screw drive assembly 406.

Lower stage base 384 includes a pair of rails 422 and 424 projecting from top surface 388 at proximal end 394 and distal end 396, respectively, of lower stage base 384. Rails 422 and 424 each have an inner surface 426 and an opposing outer surface 428 projecting away from top surface 388 and extending from first lateral side 398 to second lateral side 398 of lower stage base 384. A top surface 430 extends between inner surface 426 and outer surface 428. Rails 422 and 424 extend from first lateral side 398 to second lateral side 400 of lower stage base 384 so as to be parallel to one other.

Returning to FIG. 11, upper stage base 238 comprises a main body 432 having an elongated plate like configuration with a top surface 434, an opposing bottom surface 436, and a perimeter sidewall 438 extending therebetween. Main body 432 extends between a proximal end 440 and a spaced apart distal end 442, and between a first lateral side 444 and a second lateral side 446. Main body 432 also has an interior sidewall 448 that bounds an opening 450 extending all the way through main body 432 from top surface 434 to bottom surface 436.

Extending along and upwardly projecting from first lateral side 444 of main body 432 is an upper screw drive assembly 452 that extends between a proximal end 454 and a spaced apart distal end 456. Upper screw drive assembly 452 is configured to move chamber assembly 136 in the x-direction when chamber assembly 136 is mounted on upper stage base 238. Similar to lower screw drive assembly 406, upper screw drive assembly 452 comprises a housing 458 extending along and upwardly projecting from first lateral side 444 of main body 432. An elongated opening 464 is formed along the length of housing 458 on the side facing main body 432. An elongated screw drive 236 is rotatably disposed within housing 458. One or more helical threads are formed along the length of screw drive 452 and are openingly exposed through opening 464. A motor 460 is mounted on the end on screw drive 452 and facilitates rotation of screw drive 452 about longitudinal axis thereof

With continuing reference to FIG. 11, similar to lower screw drive assembly 406, control and data signals are sent between system controller 112 and upper screw drive assembly 238 via one or more wires (not shown). For example, control signals directing motor 460 when to rotate screw drive 236 and in which direction (clockwise or counterclockwise) are sent from system controller 112 to upper screw drive assembly 238. Information concerning the relative location of chamber assembly 136 relative to upper screw drive assembly 238 is sent from upper screw drive assembly 238 to system controller 112. Other control and data signals can also be sent between system controller 112 and upper screw drive assembly 238.

Upper stage base 238 includes a pair of rails 466 and 468 projecting upward from top surface 434 at first and second lateral sides 444 and 446, respectively, of main body 432. Rails 466 and 468 each have an inner surface 470 and an opposing outer surface 472 projecting away from top surface 434 and extending from proximal end 454 to distal end 442 of upper stage base 238. A top surface 474 extends between inner surface 470 and outer surface 472. Rails 466 and 468 extend from proximal end 440 to distal end 442 of upper stage base 238 so as to be parallel to one other.

Returning to FIG. 12 in conjunction with FIG. 11, upper stage base 238 also includes a pair of rails 476 and 478 projecting downward from bottom surface 436. Rails 476 and 478 are disposed proximally and distally from opening 450, respectively. Rails 476 and 478 each have an outer surface 480 projecting away from bottom surface 436 to a bottom surface 482. Rails 476 and 478 each extend from first lateral side 444 to second lateral side 446 of upper stage base 238 so as to be parallel to one other. Rails 476 and 478 are situated on bottom surface 436 of upper stage base 238 such that when upper stage base 238 is mounted on lower stage base 384, outer surfaces 480 of rails 476 and 478 respectively bias against inner surfaces 426 of rails 422 and 424.

Upper stage base 238 includes an engaging member 484 projecting therefrom to aid in selectively moving upper stage base 238 in the y direction. Engaging member 484 projects down from bottom surface 436 and is situated on bottom surface 436 such that when upper stage base 238 is mounted on lower stage base 384, engaging member 484 extends through opening 420 of lower stage base 384 and is engaged by screw drive 416 to move upper stage base 238 in the y direction, as described in more detail below.

With continuing reference to FIG. 12, as noted above upper stage base 238 is movably mounted on lower stage base 384 so as to be able to move in the y direction only with respect to lower stage base 384. Upper stage base 238 is mounted on lower stage base 384 such that outer surfaces 480 of rails 476 and 478 of upper stage base 238 bias against inner surfaces 426 of rails 422 and 424 of lower stage base 384, respectively. In this assembled state, at least a portion of bottom surface 436 of upper stage base 238 between rails 476 and 478 biases against top surface of lower stage base 384 between rails 422 and 424. Engaging member 484 of upper stage base 238 extends through opening 420 of lower stage base 384 and is engaged by screw drive 416. When motor 414 is energized, screw drive 416 rotates about longitudinal axis 418. As screw drive 416 rotates, it engages engaging member 484, causing upper stage base 238 to move in the y direction. To move upper stage base 238 in the reverse y direction, screw drive 416 is rotated about longitudinal axis 418 in the reverse direction. As upper stage assembly 238 moves in the y direction, upper stage assembly 238 is kept from moving in the x direction by the biasing of rails 422, 424 to rails 476, and 478. Lower stage base 384 is rigidly mounted to stage housing 120 so as not to move in either the x or the y directions.

As noted above, chamber assembly 136 is configured to be movable in the x and y directions. To facilitate this, assembled chamber assembly 136 is movably mounted on upper stage base 238 so as to be able to move in the x direction only with respect to upper stage base 238.

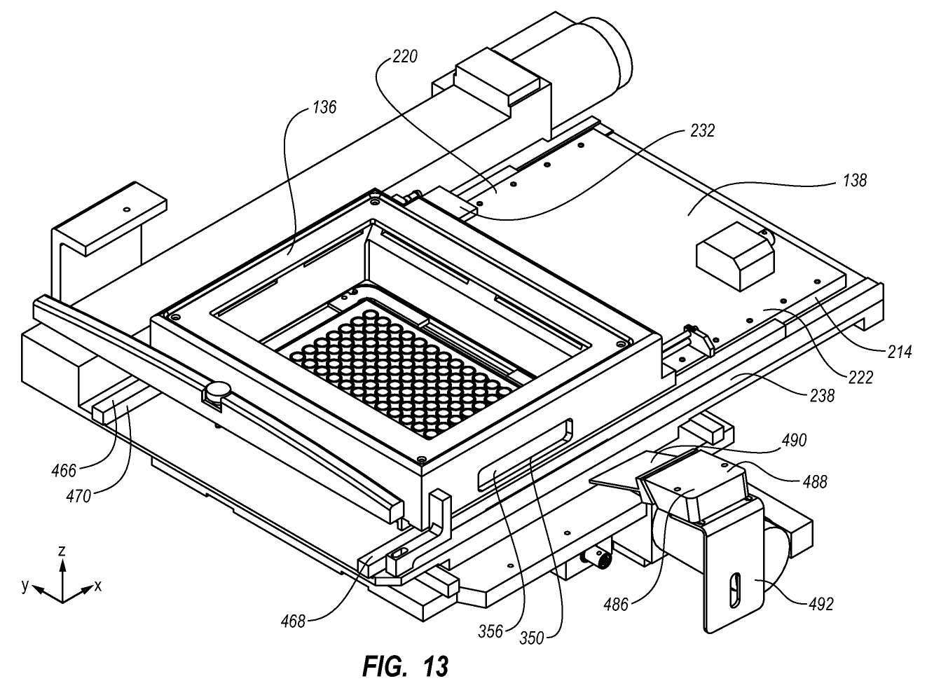

As shown in FIGS. 12 and 13, chamber assembly 136 is mounted on upper stage base 238 such that perimeter sidewall 214 of stage insert 138 at first lateral side 220 and second lateral side 222 respectively bias against inner surfaces 470 of rails 466 and 468 of upper stage base 238. (For clarity purposes only stage insert 138 of chamber assembly 136 is shown in FIG. 12). In this mounted state, at least a portion of bottom surface 212 of stage insert 138 biases against top surface of upper stage base 238 between rails 466 and 468. Projection 234 of engaging member 232 of stage insert 138 extends through opening 464 of upper stage base 238 and is engaged by screw drive 236. When motor 460 is energized, screw drive 236 rotates about longitudinal axis 462. As screw drive 236 rotates, it engages projection 234, causing stage insert 138 (and thus chamber assembly 136) to move in the x direction. To move chamber assembly 136 in the reverse x direction, screw drive 236 is rotated about longitudinal axis 462 in the reverse direction. As chamber assembly 136 moves in the x direction, chamber assembly 136 is kept from moving in the y direction with respect to upper stage base 238 by the biasing of lateral sides 220 and 222 of stage insert 138 to rails 466 and 468.

Because upper stage base 238 is movable in the y direction with respect to lower stage base 384, when chamber assembly 136 is movably mounted on upper stage base 238 as described above, chamber assembly 136 is then movable in the x direction (by virtue of moving stage insert 138 with respect to upper stage base 238) and in the y direction (by virtue of moving upper stage base 238 with respect to lower stage base 384).

Turning to FIG. 13 in conjunction with FIG. 7, as noted above, in some embodiments chamber assembly 136 is configured to allow optical identifier 348 or other identifier located on specimen plate 204 to be read through opening 350 located in perimeter wall 274 of chamber housing 202 when specimen plate 204 has been received within chamber assembly 136. To facilitate this, a means for reading the specimen plate identifier can be disposed within stage housing 120. For example, in the depicted embodiment an optical reader 486 is disposed within stage housing 120 adjacent to chamber assembly 136. Optical reader 486 comprises a main body 488 having a scanner 490 attached thereto. Optical reader 486 is situated such that scanner 490 can read optical identifier 348 through window 356 disposed in opening 350. Optical reader is typically rigidly mounted to stage housing 120, such as by bracket 492 or other attaching method. As such, screw drive 236 moves chamber assembly 136 in the x direction to a predetermined position where optical identifier 348 and opening 350 are aligned with scanner 490 before optical identifier 348 is read. Optical reader 486 can take the form of a bar code reader or other type of optical reader as is known in the art. Other types of means for reading the specimen plate identifier can alternatively be used, depending on the type of means for identifying that are used. For example, an electronic scanner, such as is known in the art, can be used when an electronic identifier is embedded within or attached to specimen plate 204.

Control and data signals are sent between system controller 112 and optical reader 486 via one or more wires (not shown). For example, control signals directing optical reader 486 when to read optical identifier 348 are sent from system controller 112 to optical reader 486 and the scanned optical identifier is sent from optical reader 486 to system controller 112. Other control and data signals can also be sent between system controller 112 and optical reader 486.

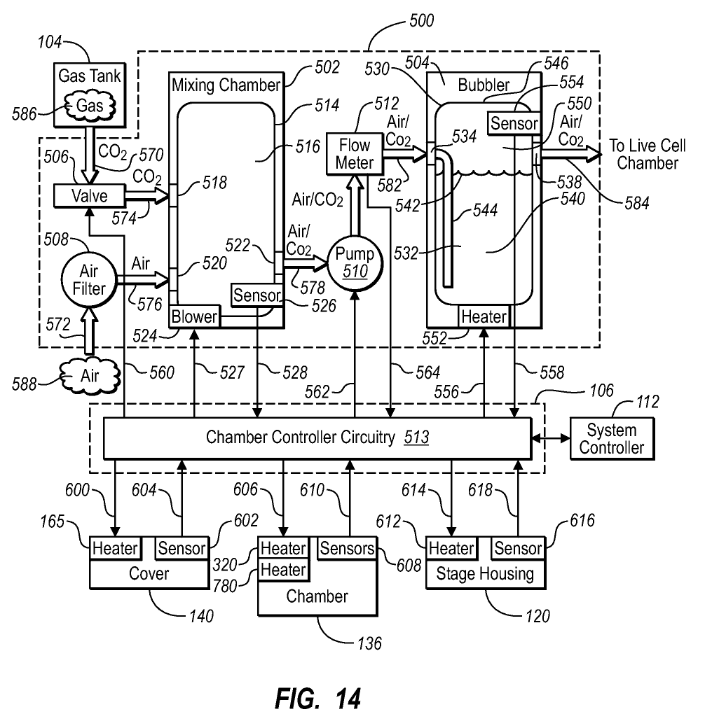

As noted above, in some embodiments a gas stream is used to help keep cells alive during the scanning process. In one embodiment, a gas preparation system 500 is used to mix, humidify, and heat the gas before the gas is used in HCS system 102. Turning to the block diagram of FIG. 14, gas preparation system comprises a mixing chamber 502, a bubbler 504, and various support devices, including a gas valve 506, an air filter 508, a pump 510, and a flow meter 512. Gas preparation system is controlled by hardware and/or software controller circuitry, such as circuitry 513 within chamber controller 106. System controller 112 can also be used in the control of gas preparation system 500 for user input of desired mixing, humidity, or temperature ranges, or for monitoring of current values, or for any other purpose.

Mixing chamber 502 is used to mix together air and a compressed gas, such as CO₂, to produce an air/gas mixture having a predetermined percentage of gas per unit volume. Mixing chamber 502 comprises a housing 514 bounding a chamber 516, the housing including a gas inlet 518, an air inlet 520, and a gas outlet 522 formed thereon and fluidly coupled to chamber 516. It is through gas inlet 518 and air inlet 520 that CO₂ and air, respectively are received within chamber 516. It is through gas outlet 522 that the air/CO₂ gas mixture is output.

A blower 524 is positioned within housing 514 or attached thereto to mix the CO₂ and air together to produce the air/CO₂ gas mixture. Blower 524 is fluidly coupled to chamber 516 so that the gaseous contents of chamber 516 are mixed when blower 524 is energized. Blower 524 can comprise a conventional squirrel-cage type blower or other type of blower known in the art. A gas sensor 526 is positioned within chamber 516 to monitor the percentage of CO₂ within chamber 516. Gas sensor 526 can comprise any type of gas sensor known in the art. Blower 524 and gas sensor 526 are configured to be electronically connected to an external controller, such as chamber controller 106. In the embodiment depicted, blower 524 is controlled via one or more control lines denoted by arrow 527 and the output of gas sensor 526 is monitored via one or more sensor lines denoted by arrow 528.

With continuing reference to FIG. 14, bubbler 504 is used to humidify the air/CO₂ gas mixture before the gas mixture is sent to chamber assembly 136. In some embodiments, bubbler 504 is also used to preheat the gas mixture. Bubbler 504 comprises a housing 530 bounding a chamber 532, the housing including a gas inlet 534 and a gas outlet 538 formed thereon and fluidly coupled to chamber 532. Chamber 532 is filled with water 540 to a predetermined level 542. It is through gas inlet 534 that the air/CO₂ gas mixture is received within chamber 532. It is through gas outlet 538 that the air/CO₂ gas mixture is output.

Gas inlet 534 and gas outlet 538 are both situated such that the gas mixture passes through water 540 disposed within chamber 532 when traveling from gas inlet 534 to gas outlet 538. In one embodiment this is accomplished by disposing a tube 544 or the like within chamber 532. Tube 544 is fluidly coupled to gas inlet 534 such that the gas that enters bubbler 504 through gas inlet 534 passes through tube 544. Tube 544 extends from gas inlet 534 downward past the predetermined level 542 of water and terminates toward the bottom of chamber 532. As a result, the gas mixture that enters bubbler 504 through gas inlet 534 passes downward through tube 544 disposed within chamber 532 before entering chamber 532. The gas mixture must then rise through the water 540 to exit gas chamber 550 through gas outlet 538. As the gas mixture passes through water 540, the gas mixture absorbs some of the water and thereby becomes humidified.

A gas sensor 554 is positioned within gas chamber 550 to monitor the humidity of the gas mixture within gas chamber 550 as the gas mixture exits gas chamber 550 via gas outlet 538. In one embodiment, a heater 552 is positioned within housing 530 or attached thereto to heat the water within chamber 532. By heating the water, the gas that passes through the water is also heated. Heater 552 can comprise a sleeve into which housing 530 is inserted, a conventional electrical coil or other type of heater known in the art. If a heater is used in bubbler 504, gas sensor 554 also monitors the temperature of the gas mixture. Gas sensor 554 can comprise any type of gas sensor known in the art or can comprise multiple sensors. Heater 552 and gas sensor 554 are configured to be electronically connected to an external controller, such as chamber controller 106. In the embodiment depicted, heater 552 is controlled via one or more control lines denoted by arrow 556 and the output of gas sensor 554 is monitored via one or more sensor lines denoted by arrow 558.

With continuing reference to FIG. 14, the support devices (gas valve 506, air filter 508, pump 510, and flow meter 512) are used to facilitate the movement and monitoring of the air, the gas, and the air/gas mixture through gas preparation system 500. For example, gas valve 506 is used to control the amount of gas entering mixing chamber 502 via gas inlet 518. Air filter 508 is used to filter the air before the air enters mixing chamber 502 via air inlet 520. Pump 510 is used to facilitate the movement of the air/CO₂ gas mixture between gas outlet 522 on mixing chamber 502 and gas inlet 534 on bubbler 504. Flow meter 512 is used to determine the rate at which the air/CO₂ gas mixture is flowing between gas outlet 522 on mixing chamber 502 and gas inlet 534 on bubbler 504. Gas valve 506, air filter 508, pump 510, and flow meter 512 can be conventional devices or other devices known in the art. It is appreciated that other support devices may also be included as is known in the art. For example, other filters, valves or pumps can be included as needed.

Gas valve 506, air filter 508, pump 510, and flow meter 512 are configured to be electronically connected to an external controller, such as chamber controller 106. In the embodiment depicted, gas valve 506 and pump 510 are each controlled via one or more control lines denoted by arrows 560 and 562, respectively. The output of flow meter 512 is monitored via one or more sensor lines denoted by arrow 564.

Various gas lines are also included in gas preparation system to pass the gas, air, or mixed gas from one device to another. For example, in the depicted embodiment, gas lines 570-584 enable the various gases to flow through gas preparation system 500. Gas line 570 connects gas tank 104 to gas valve 506 to enable gas to flow therebetween. Gas line 572 connects to air filter 508 to enable ambient air to be inputted into air filter 508. Gas line 574 connects gas valve 506 to gas inlet 518 on mixing chamber 502 to enable gas to flow therebetween. Gas line 576 connects air filter 508 to air inlet 520 on mixing chamber 502 to enable air to flow therebetween. Gas line 578 connects gas outlet 522 on mixing chamber 502 to pump 510 to enable gas to flow therebetween. Gas line 580 connects pump 510 to flow meter 512 to enable gas to flow therebetween. Gas line 582 connects flow meter 512 to gas inlet 534 on bubbler 504 to enable gas to flow therebetween. Gas line 584 connects to gas outlet 538 on bubbler 504 to enable gas to flow therefrom to the HCS system.

With continuing reference to FIG. 14, during operation a compressed gas 586, such as CO₂, is inputted from pressurized gas tank 104 into chamber 516 of mixing chamber 502 by passing the gas through gas line 570, gas valve 506, gas line 574, and through gas inlet 518. Gas valve 506 is opened and closed to selectively allow compressed gas 570 to pass into mixing chamber 502 via the one or more control signals 560 sent to gas valve 506 by chamber control circuitry 513. Opening and closing gas valve 506 controls the flow of gas into mixing chamber 502 which effectively controls the percentage of CO₂ disposed within mixing chamber 502.

Ambient air 588 is also inputted into chamber 516 of mixing chamber 502. The air is passed through gas lines 572, air filter 508, gas line 576, and through air inlet 520. It is appreciated that gas line 576 can be omitted and the ambient air can simply flow into air filter without first passing through a gas line. The amount of air that flows into mixing chamber 502 is dependent on the amount of gas 570 that flows into mixing chamber 502 and the status of blower 524 and pump 510. The higher the pumping rate is, the more air that is inputted into mixing chamber 502.

The gas and air that is inputted into chamber 516 of mixing chamber 502 is mixed together by blower 524. Chamber controller circuitry 513 continuously or periodically monitors gas sensor 526 via the one or more sensor lines 528 to determine the percentage of CO₂ within the air/CO₂ gas mixture. To change the percentage of CO₂ gas within the air/CO₂ gas mixture within mixing chamber 502, chamber controller circuitry 513 can open/close valve 506 and/or change the rate at which pump 510 removes the gas mixture from mixing chamber 502. Chamber controller circuitry 513 opens and closes valve 506 via control line(s) 560, as discussed previously, to change the CO₂ gas flow. Chamber controller circuitry 513 changes the pumping rate of pump 501 via control line(s) 562, as discussed previously, which changes the flow rate at which the air/CO₂ gas mixture exits mixing chamber 504, which in turn changes the flow rate of the air 588 flowing into mixing chamber 502 to replace the exiting air/CO₂ gas mixture. In this manner, chamber controller circuitry 513 maintains the percentage of CO₂ gas within the air/CO₂ gas mixture at a predetermined percentage.

In some embodiments, chamber controller circuitry 513 maintains the percentage of CO₂ gas within the air/CO₂ gas mixture within chamber 516 to be between about 0.1% to about 12% with about 4% to about 6% being more common. Other percentage ranges can also be used.

With continuing reference to FIG. 14, the air/CO₂ gas mixture is passed from chamber 516 of mixing chamber 502 to bubbler 504 by passing the gas through gas outlet 522, gas line 578, pump 510, gas line 580, flow meter 512, gas line 582, and through gas inlet 534. Chamber controller circuitry 513 continuously or periodically monitors flow meter 512 via the one or more sensor lines 564 to determine the amount of air/CO₂ gas mixture flowing into bubbler 504. The rate can be lowered or raised by modifying the pumping rate of pump 510, as discussed above.

As discussed previously, bubbler 504 is configured such that a gas inputted through gas inlet 534 passes through tube 544 to the bottom of bubbler 504 and thus must pass through water 540 before exiting bubbler 504 through gas outlet 538. Because of the pressure caused by pump 510, the air/CO₂ gas mixture that is inputted into bubbler 504 does just that. That is, the air/CO₂ gas mixture that enters bubbler 504 is forced to bubble up through water 540 until the air/CO₂ gas mixture rises to the top of water 540 into gas chamber 550. As the air/CO₂ gas mixture passes through water 540, the air/CO₂ gas mixture becomes humidified.

Chamber controller circuitry 513 continuously or periodically monitors gas sensor 554 via the one or more sensor lines 558 to determine the humidity of the air/CO₂ gas mixture disposed within gas chamber 550. To change the humidity of the air/CO₂ gas mixture within gas chamber 550, chamber controller circuitry 513 can change the rate at which the air/CO₂ gas mixture moves through water 540 and/or change the water level 542. Chamber controller circuitry 513 changes the pumping rate of pump 501 via control line(s) 562, as discussed previously, to change the air/CO₂ gas mixture flow rate into bubbler 504, which directly changes the rate at which the air/CO₂ gas mixture moves through water 540. In this manner, chamber controller circuitry 513 maintains the humidity of the air/CO₂ gas mixture exiting bubbler 504 at a predetermined humidity level.

In some embodiments, chamber controller circuitry 513 maintains the humidity level of the air/CO₂ gas mixture within gas chamber 550 to be between about 60% to about 95% relative humidity with about 70% to about 80% relative humidity being more common. Other humidity levels can also be maintained.

As discussed previously, heater 552 can be included to heat water 540 that is used in bubbler 504, which in turn heats the air/CO₂ gas mixture. As noted above, when heater 552 is used, gas sensor 554 also monitors the temperature of the gas mixture. When heater 552 is included with bubbler 504, as in the depicted embodiment, chamber controller circuitry 513 continuously or periodically monitors gas sensor 554 via the one or more sensor lines 558 to determine the temperature of the air/CO₂ gas mixture disposed within gas chamber 550. To change the temperature of the air/CO₂ gas mixture within gas chamber 550, chamber controller circuitry 513 changes the operating temperature of heater 552 via control line(s) 556, as discussed previously, to change the water temperature within chamber 532, which directly changes the temperature of the air/CO₂ gas mixture that moves through water 540. In this manner, chamber controller circuitry 513 maintains the temperature of the air/CO₂ gas mixture exiting bubbler 504 at a predetermined temperature.

In some embodiments, chamber controller circuitry 513 maintains the temperature of the air/CO₂ gas mixture within gas chamber 550 to be between about 40° C. to about 50° C. Other temperature ranges can also be maintained.

With continuing reference to FIG. 14, the humidified air/CO₂ gas mixture is passed from gas chamber 550 of bubbler 504 to HCS system 102 by passing the gas through gas outlet 538, and gas line 584, which extends to HCS system 102. Gas line 584 can be fluidly connected to gas inlet port 302 by using a standard coupling connected to coupling 310. It is appreciated that other valves, couplers, gas lines can also be used to connect gas preparation system 500 to HCS system 102, as is known in the art.

Although all of the methods and elements of gas preparation system 500 are disclosed as being controlled by a common controller (chamber controller 106), it is appreciated that one or more of the recited methods and elements can alternatively be controlled by a plurality of controllers.

As noted above, in addition to heating of the air/CO₂ gas mixture before it is used within HCS system 102, other means for heating can be used within HCS system 102 to maintain the live cells at a predetermined temperature. For example, as described above, in some embodiments, various heaters, such as gradient heaters 780, are disposed on or around chamber assembly 136. These heaters are configured to be electronically controlled by an external controller, such as chamber controller 106. To facilitate this, various sensors can also be included to provide feedback to the external controller. For example, in the embodiment depicted in FIG. 14, separate heaters and corresponding temperature sensors are located in second cover 140 above chamber assembly 136, on one or more surfaces of chamber assembly 136, and/or within a portion of stage housing 120 underneath chamber assembly 136, such as within compartment 125.

As noted above, heater layer 146 of second cover 140 can include a heater element 165 Chamber controller circuitry 513 controls heater 165 via one or more control lines denoted by arrow 600. A corresponding temperature sensor 602 is disposed near heater 165. Chamber controller circuitry 513 monitors the output of temperature sensor 602 via one or more sensor lines denoted by arrow 604 to determine the amount of heat generated by heater 165 and adjusts heater 165 to help maintain compartment 300 of chamber assembly 136 at a predetermined temperature.

Also as noted above, heating element 320 and/or gradient heaters 780 can be disposed on or within perimeter wall 274 of chamber housing 202. Heating element 320 and/or gradient heaters 780 can be taped to or otherwise attached to perimeter wall 274. Chamber controller circuitry 513 controls heaters 320 and 780 via one or more control lines denoted by arrow 606. One or more corresponding temperature sensors 608 are disposed near heaters 320 and 780. Chamber controller circuitry 513 monitors the output of each temperature sensor 608 via one or more sensor lines denoted by arrow 610 to determine the amount of heat generated by heaters 320 and 780 and adjusts heaters 320 and 780 to help maintain compartment 300 of chamber assembly 136 at a predetermined temperature.

As noted above, another heater 612 can be disposed within compartment 125 located underneath chamber assembly 136. Also as noted above, blower 710 can be mounted near heater 612 and configured to blow the heated air under chamber assembly 136. Chamber controller circuitry 513 controls heater 612 (and blower 710, if used) via one or more control lines denoted by arrow 614. A corresponding temperature sensor 616 is disposed near heater 612. Chamber controller circuitry 513 monitors the output of temperature sensor 616 via one or more sensor lines denoted by arrow 618 to determine the amount of heat generated by heater 612 and adjusts heater 612 to help maintain compartment 300 of chamber assembly 136 at a predetermined temperature.

It is appreciated that other heaters can also be used in HCS system 102. For each of these heaters corresponding temperature sensors can be included which provide feedback to chamber controller circuitry 513 to allow chamber controller circuitry 513 to control the additional heaters in a manner similar to the heaters detailed above.

With general reference to FIG. 15, in conjunction with FIGS. 1-14, a method of operation according to one embodiment of scanning system 100 is now given. As noted above in reference to FIG. 1, one or more specimen plates 204 having wells 374 containing fixed cells or live cells are typically stored in plate rack 110 or incubator 770, respectively. A desired specimen plate 204 is selected from the one or more specimen plates within plate rack 110 or incubator 770 to load into HCS system 102. This selection can be performed by hand or by robot 108, as described above. It is also appreciated that robot 108, plate rack 110, and/or and incubator 770 can be omitted and the desired specimen plate simply chosen external to scanning system 100.

In any case, for specimen plate 204 to be loaded into stage housing 120 of HCS system 102, chamber assembly 136 is moved to the retracted position such that chamber housing 202 is extending out from recess 142, as depicted in FIG. 3. Once chamber housing 202 is positioned, specimen plate 204 is placed on plate holder 200 so that the plurality of wells 374 communicate with compartment 300 of chamber housing 202. This is accomplished by inserting specimen plate 204 into compartment 300 and lowering specimen plate 204 until portion 382 of perimeter sidewall 372 of specimen plate 204 rests on lip 272 of plate holder 200, as discussed above and shown in FIG. 7. In this manner, specimen plate 204 is at least partially disposed within compartment 300 of chamber housing 202.

To unload specimen plate 204 from stage housing 120 of HCS system 102, specimen plate 204 is lifted off of plate holder 200 and removed through compartment 300 in substantially reverse order as when plate holder 200 is loaded. Similar to loading, unloading of specimen plate 204 is performed when chamber housing 202 is extending out from recess 142, as depicted in FIG. 3.

Once specimen plate 204 has been successfully inserted into chamber assembly 136, as detailed above, chamber assembly 136 is then retracted back into recess 142 such that until chamber housing 202 becomes disposed directly underneath second cover 140, as shown in FIG. 15. As chamber assembly 136 is being retracted, beveled edge 299 of distal wall segment 282 comes into contact with second cover 140. As chamber assembly 136 is retracted further, top cover 734 is pushed up by chamber assembly 136 so that chamber assembly 136 can slide under top cover 734. This is facilitated by virtue of the attachment of top cover 734 to bracket assemblies 800, as previously discussed with regard to FIG. 3A. As chamber assembly 136 advances under top cover 734, perimeter wall 274 engages against the bottom surface of second cover 140.

If registration mechanism 740 is used (see FIG. 10A), a force is applied to end plate 744 as chamber assembly 136 is retracted into recess 142 which causes biasing member 742 to bias against and register specimen plate so as to rigidly fix the position of specimen plate 204 with respect to plate holder 200, as described above.

Once chamber assembly 136 is fully disposed in the retracted position, perimeter wall 274 at the upper end 296 of chamber housing 202 abuts bottom surface 182 of bottom layer 150 of second cover 140 of stage housing 120 so as to form a seal therebetween, as shown in FIG. 15. If used, compressible member 301 forms the seal. The seal that is formed is such as to prevent gas within compartment 300 from flowing out between perimeter wall 274 and second cover 140 of stage housing 120. This forces gas to travel down through compartment 300 and flow out of compartment 300 between lip 272 of plate holder 200 and sidewall 372 of specimen plate 204 at a rate which allows a positive gas pressure within compartment 300 to be held within a predetermined range. The flow rate is chosen so as to eliminate eddies and prevent unwanted gas from entering the chamber without causing excessive evaporation within compartment 300. During operation, the flow rate of the gas through compartment 300 is typically in a range between about 1 liter/min to about 5 liters/min with about 1 liter/min to about 2 liters/min being more common. Other rates can also be used.

Once specimen plate 204 has been loaded into position, optical reader 486 can read optical identifier 348 through window 356, if desired by the user, and send the scanned optical identifier to system controller 112, as discussed above with reference to FIG. 13. System controller 112 can use the optical identifier to then determine the environmental and HCS conditions desired for the particular specimen plate that has been loaded. For example, by knowing the particular specimen plate to be scanned, the system controller can determine the temperature, humidity, and/or gas concentration settings and cause these environmental conditions to be used. The system controller can also determine the wavelengths by channel, exposure conditions, measurement parameters, and the like and cause the HCS to use these settings when scanning the specimen plate.

As noted above, to keep the cells within wells 374 alive, a cell-sustaining gas is pumped into compartment 300. The gas, typically an air/CO₂ gas mixture, is received under pressure at gas inlet port 302 of chamber housing 202 via a standard gas hose (not shown) that has been fluidly coupled to coupling 310, as discussed above with reference to FIG. 8. The gas mixture passes through gas inlet port 302 and gas pathway 304, and enters compartment 300 through gas outlet ports 306, as described above. As noted above, the butting up of perimeter wall 274 against second cover 140 prevents the gas mixture from escaping compartment 300 at the abutment therebetween. On the other hand, as noted above, the junction between the specimen plate 204 and lip 272 is configured to create a partial seal that allows the gas mixture to “leak” out of compartment 300 as more gas mixture is being forced into compartment 300 so as to maintain a positive gas pressure within compartment 300. This forces the gas mixture to move downward through compartment 300 during operation. In some embodiments, the gas mixture is heated as it passes through gas pathway 304 by heater 320 (see FIG. 10), also as described above. If desired, the air/CO₂ gas mixture can be heated and/or humidified before being received at gas inlet port 302. In some embodiments, this is accomplished using gas preparation system 500, as discussed above with reference to FIG. 14.

As noted above with reference to FIG. 14, heaters 165, 320, and 612 and corresponding sensors 602, 608, and 616, respectively, are used to maintain compartment 300 at a predetermined temperature. Also as noted above, other heaters and sensors can also be used, such as gradient heaters 780. By using multiple heaters at different positions around and within chamber assembly 136, a more uniform heating of all of the cells disposed on specimen plate 204 can be realized. These heating and sensing elements help maintain compartment 300 at a temperature range of about 40° C. to about 50° C. Other temperature ranges can also be used.

Means for conducting high content screening of live cells disposed within the wells of the specimen plate is facilitated using embodiments of the current invention. As shown in FIG. 15, when the live cells disposed within a particular well 374A are to be scanned, specimen plate 204 is moved in the x and y directions so that well 374A is situated directly above a desired lens 127 within lens assembly 126 of microscope 122. As noted above, once inserted, specimen plate 204 is fixed within chamber assembly 136, so that by moving chamber assembly 136, well 374A is also moved.

As described above, stage assembly 206 is used to move chamber assembly 136 two dimensionally (i.e., in the x and y directions) with respect to second cover 140 and microscope 122. As a result, stage assembly 206 is used to move well 374A to the desired x and y location. That is, screw drive 236 of upper stage base 238 moves stage insert 138 in the x direction while screw drive 416 of lower stage base 384 moves upper stage base 238 containing stage insert 138 in the y direction until well 374A arrives at its desired location, as explained above.

By maintaining second cover 140 stationary with respect to microscope 122, the cover aperture 186 can remain aligned above lens 127 of microscope 122 while chamber assembly 136 is moved. This allows the pipettor or light source that is mounted or otherwise positioned on second cover 140 to remain stationary throughout the scanning process, which helps minimize potential errors. This placement and formation of the gas outlet ports 306 helps produce a uniform distribution of gas within compartment 300 to help optimize cell viability.

With continuing reference to FIG. 15, as stage insert 138 is moved in both the x and y directions, chamber housing 202 is also moved by virtue of chamber housing 202 being attached to stage insert 138, as discussed above. When chamber housing 202 is moved by stage assembly 206, perimeter wall 274 at the upper end 296 of chamber housing 202 slides against bottom surface 182 of bottom layer 150 of second cover 140 so as to maintain the seal as discussed above. As a result, the positive gas pressure discussed above is maintained within compartment 300 even while chamber assembly 136 is being moved by stage assembly 206.

Once well 374A is positioned over lens 127, high content screening of the live cells within well 374A of specimen plate 204 through bottom surface 368 of specimen plate 204 occurs in a conventional manner using microscope 122. Once screening has been completed, another well 374 can be moved over lens 127 by stage assembly 206 and the live cells deposited therein can be scanned or screened using microscope 122 in a like manner. This can continue until a portion or all of wells 374 are scanned or screened.

As discussed above with regard to FIGS. 2 and 4, cover aperture 186 is formed such that one or more pipettors (not shown) can inject one or more liquids or other material through cover aperture 186 into wells 374. To do so, pipettor guide 196 and pipettor mount 194 are secured to cover aperture 186. The one or more wells 374 of specimen plate 204 that are to receive the injections are moved by stage assembly 206, as discussed above, until aligned with cover aperture 186. Once wells 374 are in position, the pipettor simultaneously performs the injections into the wells through pipettor guide 196.

Alternatively, as noted above, means for illuminating specimen plate 204 can be shined through cover aperture 186 so that high content screening of the live cells can be performed in bright field mode. For example, in the depicted embodiment LED 189 is mounted on second cover 140 of stage housing 120 so as to be aligned with cover aperture 186. LED 189 shines through cover aperture 186 using bright field illumination so as to shine light down on the top surface 364 of specimen plate 204 as the live cells are scanned. In this manner, the live cells are screened in bright field mode.

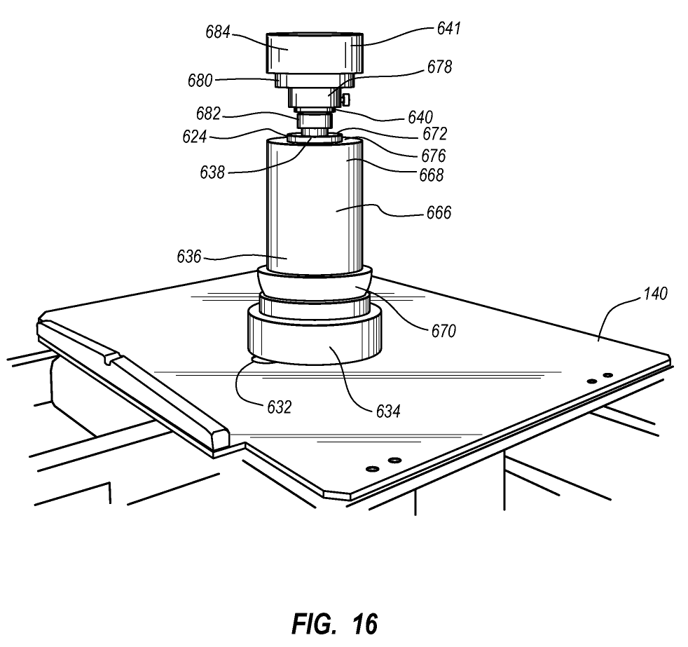

Other means for illuminating the specimen plate 204 can alternatively be used in place of LED 189. For example, FIG. 16 shows a light assembly 630 that can be used as an alternative embodiment of a means for illumination. Light assembly 630 comprises a plug 632, a condenser lens adapter 634 mounted to plug 632, a condenser lens 636 mounted onto condenser lens adapter 634, a light source adapter 638 mounted onto condenser lens 636, and a light source 640 mounted onto light source adapter 638. In some embodiments a heat sink 641 may also be mounted on light source 640 to dissipate heat generated by light assembly 630.

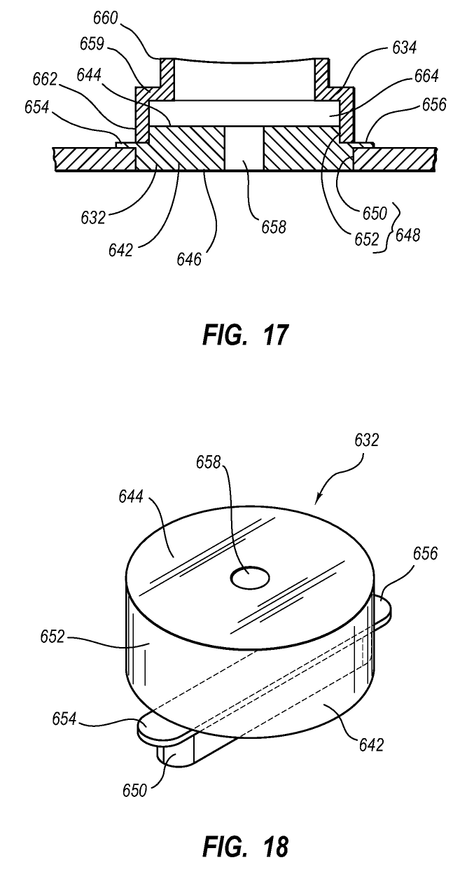

Turning to FIGS. 17 and 18, plug 632 is sized and shaped to be at least partially received within cover aperture 186. Plug 632 comprises a main body 642 having a top surface 644 and a bottom surface 646 with a perimeter sidewall 648 extending therebetween. Perimeter sidewall 648 comprises a lower portion 650 and an upper portion 652. Lower portion 650 is sized to snugly fit within cover aperture 186 and upper portion 652 is sized to allow condenser lens adapter 634 to be mounted thereon. Two lips 654 and 656 extend outward from opposite sides of perimeter sidewall 648 where lower portion 650 and upper portion 652 meet. In one embodiment, upper portion of perimeter sidewall 645 is threaded. An aperture 658 is formed in main body 642 that extends completely through main body 642 between top surface 644 and bottom surface 646. It is through aperture 658 that light emanating from light source 640 is shined. Plug 632 can be secured to second cover 140 by being bolted, threaded, glued, or by some other mounting method as is known in the art.

Returning to FIGS. 16 and 17, condenser lens adapter 634 comprises a main body 659 extending from a top end 660 to a spaced apart bottom end 662 and is used to mount condenser lens 636 to plug 632. As such, bottom end 662 is configured to mount to plug 632 and top end 660 is configured to receive condenser lens 636. A bore 664 is formed at bottom end 662 that is sized to snugly mount on upper portion 652 of plug 632. In embodiments in which upper portion 652 of perimeter sidewall 648 of plug 632 is threaded, bore 664 is also threaded to match the threads of upper portion 652, thus enabling condenser lens adapter 634 to be screwed onto plug 632. Top end 660 of condenser lens adapter 634 is threaded or otherwise configured to allow condenser lens 636 to be mounted thereon.

Condenser lens 636 is used to focus the light received from light source 640 onto aperture 658 formed on plug 632 so that maximum light can shine through aperture 658 and onto the live cells disposed within compartment 300. Condenser lens 636 comprises a housing 666 extending from a top end 668 to a spaced apart bottom end 670, with one or more lenses (not shown) housed therein configured to focus light. A conventional condenser lens is typically used, such as model Vert 40 manufactured by Carl Zeiss MicroImaging, Inc. in Goettingin, Germany. Other condenser lenses can also be used. Bottom end 670 of condenser lens 636 is mounted onto top end 660 of condenser lens adapter 634 by being bolted, threaded, glued, or by some other mounting method, as is known in the art.

With continuing reference to FIG. 16, light source adapter 638 is used to mount light source 640 to condenser lens 636. Light source adapter 638 comprises a main body 672 extending from a top end 674 to a spaced apart bottom end 676. Bottom end 676 is configured to mount to condenser lens 636 and top end 674 is configured to receive light source 640. Bottom end 676 of light source adapter 638 is mounted onto top end 668 of condenser lens 636 by being bolted, threaded, welded, or other mounting method.

Light source 640 provides the light that is focused onto and passed through aperture 658. Light source 640 comprises a housing 678 extending from a top end 680 to a spaced apart bottom end 682, with a light emitting device (not shown) housed therein. A diode light source is typically used, such as model Bright Light II manufactured by Navitar Inc. Other light sources can also be used. Bottom end 682 of light source 640 is mounted onto top end 668 of condenser lens 636 by being bolted, threaded, welded, or by some other mounting method, as is known in the art.

In some embodiments, heat sink 641 is used to transfer heat that builds up during use away from light assembly 630. Heat sink 641 comprises a main body 684 that is mounted to top end 680 of light source 640 so as to thermally communicate with light source 640. Heat that is generated by light source 640 is then transferred to the ambient air via heat sink 641. Heat sink 641 is mounted onto light source 640 by being bolted, threaded, welded, or by some other mounting method, as is known in the art.

A controller, such as system controller 112, can be used to identify when to activate light source 640. Other controllers can alternatively be used.

Turning to FIG. 15 in conjunction with FIG. 16, as noted above and similar to LED 189, light assembly 630 is mounted to second cover 140 of stage housing 120 so as to be aligned with cover aperture 186. When bright field mode is desired, the light emitting device within housing 678 of light source 640 is energized, which shines light therefrom. The light shines through light source adapter 638 and is focused by condenser lens 636 onto aperture 658 of plug 632. The focused light passes through aperture 658, which is disposed within cover aperture 186, and illuminates the top surface 364 of specimen plate 204. This, in turn, illuminates the particular well 374 that is being scanned or screened. At the same time as illumination is occurring, microscope 122 scans upward through bottom surface 368 of specimen plate 204 through bottom wall 380 of well 374. In this manner, high content screening of the live cells is thus performed using microscope 122 in bright field mode.

The present invention may be embodied in other specific forms without departing from its spirit or essential characteristics. Accordingly, the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for performing live cell analysis, the apparatus comprising:
a stage housing comprising a cover having a bottom surface; and
a chamber assembly movably disposed below and movable relative to the cover of the stage housing, the chamber assembly being adapted to removably receive a specimen plate holding live cells, the chamber assembly comprising:
a chamber housing having a perimeter wall with an interior surface and an exterior surface extending from an upper end to a spaced apart lower end, the perimeter wall bounding a compartment that passes all the way through the chamber housing from the upper end to the lower end; and
at least one gas outlet port formed on the chamber housing, the gas outlet port being in communication with the compartment of the chamber housing to allow gas to enter the compartment.

2. The apparatus as recited in claim 1, wherein the perimeter wall at the upper end of the chamber housing biases against the bottom surface of the cover of the stage housing.

3. The apparatus as recited in claim 1, wherein the chamber assembly further comprises:
a gas inlet port formed on the chamber housing; and
a gas pathway extending between the gas inlet port and the at least one gas outlet port, the gas pathway having a zigzag pattern that extends along a length of the perimeter wall.

4. The apparatus as recited in claim 3, further comprising means for heating the gas within the gas pathway.

5. The apparatus as recited in claim 3, wherein the at least one gas outlet port comprises a plurality of spaced apart gas outlet ports being formed on the interior surface of the perimeter wall.

6. The apparatus as recited in claim 2, wherein the chamber housing further comprises a compressible member biased between the upper end of the perimeter wall and the bottom surface of the stage housing, the compressible member forming at least a partial seal between the perimeter wall and the bottom surface of the stage housing.

7. The apparatus as recited in claim 1, wherein the chamber assembly can move two dimensionally within the stage housing.

8. The apparatus as recited in claim 1, wherein the chamber assembly further comprises a plate holder disposed at the lower end of the chamber housing, the plate holder having an opening extending therethrough that is in alignment with the compartment bounded by the perimeter wall, the plate holder being adapted to receive a specimen plate holding live cells when a specimen plate is removably received within the chamber assembly.

9. The apparatus as recited in claim 1, further comprising a specimen plate, the specimen plate being at least partially disposed within the compartment of the chamber housing, the specimen plate having a plurality of wells formed thereon that are adapted to receive live cells.

10. The apparatus as recited in claim 9, further comprising means for conducting high content screening of live cells disposed within the wells of the specimen plate.

11. The apparatus as recited in claim 9, wherein the chamber assembly further comprises a plate holder disposed at the lower end of the chamber housing, the plate holder having an opening extending therethrough that is in alignment with the compartment bounded by the perimeter wall, the specimen plate being removably positioned on the plate holder.

12. The apparatus as recited in claim 1, further comprising means for resiliently biasing the bottom surface of the cover against the perimeter wall at the upper end of the chamber housing.

13. The apparatus as recited in claim 12, wherein the means for resiliently biasing comprises a bracket assembly onto which the cover is mounted, the bracket assembly having a spring.

14. The apparatus as recited in claim 1, further comprising a heater mounted on or in the chamber housing.

15. The apparatus as recited in claim 14, wherein the heater comprises a gradient heater having a plurality of heating zones, at least two of the heating zones producing differing amounts of heat from each other.

16. A system for performing live cell analysis, the system comprising:
the apparatus as recited in claim 1; and
a robot adapted to insert a specimen plate into the compartment of the chamber housing and remove the specimen plate from the compartment of the chamber housing when the specimen plate is respectively inserted into and removed from the chamber assembly.

17. The system as recited in claim 16, further comprising an incubator, wherein the robot is adapted to remove a specimen plate from the incubator and insert the specimen plate into the incubator.

18. An apparatus for performing live cell analysis, the apparatus comprising:
a stage housing having a recess;
a chamber housing movably disposed within the recess of the stage housing, the chamber housing having a perimeter wall with an interior surface and an exterior surface extending from an upper end to a spaced apart lower end, the perimeter wall bounding a compartment that passes all the way through the chamber housing from the upper end to the lower end, the compartment being adapted to removably receive a specimen plate holding live cells;
at least one gas outlet port formed on the interior surface of the chamber housing, the gas outlet port being in communication with the compartment of the chamber housing to allow gas to enter the compartment;
a gas inlet port formed on the exterior surface of the chamber housing with a gas pathway extending between the gas inlet port and the at least one gas outlet port; and
means for heating gas as it travels within the gas pathway.

19. The apparatus as recited in claim 18, wherein the gas pathway has a zigzag pattern that extends along a length of the perimeter wall.

20. The apparatus as recited in claim 18, wherein the means for heating gas comprises an electrical heating element mounted on the chamber housing.

21. The apparatus as recited in claim 18, further comprising means for conducting high content screening of the live cells on the specimen plate when the specimen plate is positioned within the compartment of the chamber housing.

22. A system for performing high content screening of live cells, the system comprising:
a stage housing having a recess;
a chamber housing movably disposed within the recess of the stage housing, the chamber housing having a perimeter wall with an interior surface and an exterior surface extending from an upper end to a spaced apart lower end, the perimeter wall bounding a compartment that passes all the way through the chamber housing from the upper end to the lower end;
a specimen plate having a top surface and an opposing bottom surface, the top surface having a plurality of wells formed thereon that are adapted to receive live cells, the specimen plate being at least partially disposed within the compartment of the chamber housing so that the plurality of wells communicate with the compartment of the chamber housing;
a microscope disposed below the bottom surface of the specimen plate, the microscope being configured to perform high content screening of live cells within the plurality of wells of the specimen plate through the bottom surface of the specimen plate; and
means for illuminating the specimen plate using bright field illumination such that high content screening of the live cells can be performed in bright field mode.

23. The system as recited in claim 22, wherein the means for illuminating comprises a light source positioned to shine light down on the top surface of the specimen plate.

24. The system as recited in claim 23, wherein the light source comprises an LED mounted on the stage housing.

25. The system as recited in claim 23, wherein the light source comprises a light assembly mounted on the stage housing the light assembly being adapted to focus light onto the top surface of the specimen plate.

26. The system as recited in claim 25, wherein the light assembly comprises:
a plug having an aperture adapted to allow light to pass therethrough, the plug being mounted on the stage housing;
a condenser lens adapter configured to receive a condenser lens, the condenser lens adapter being mounted to the plug;
a condenser lens mounted onto the condenser lens adapter;
a light source adapter mounted onto the condenser lens, the light source adapter being configured to receive a light source; and
a light source mounted onto the light source adapter.

27. A method for live cell analysis, the method comprising:
inserting a specimen plate containing live cells into a compartment of a chamber housing;
illuminating the live cells using bright field illumination; and
performing high content screening of the live cells using a microscope in bright field mode.

28. The method as recited in claim 27, wherein
the act of illuminating comprises shining a light source down onto a top surface of the specimen plate; and
the act of performing high content screening comprises operating the microscope to scan upward through a bottom surface of the specimen plate.

29. A method of preparing CO₂ gas for use in a cell analysis system, the method comprising:
mixing a CO₂ gas with other gases to create a gas mixture containing a predetermined percentage of CO_{2;}
heating the gas mixture to a predetermined temperature;
humidifying the gas mixture to a predetermined humidity level, the acts of mixing, heating, and humidifying being controlled by a common controller;
delivering the heated and humidified gas mixture to a compartment of a chamber housing holding live cells; and
performing high content screening of the live cells using a microscope.

30. The method as recited in claim 29, wherein the act of mixing comprises mixing the CO₂ gas with other gases to create a gas mixture containing CO₂ in a range from about 0.1% to about 12% by volume.

31. The method as recited in claim 29, wherein the act of heating comprises heating the gas mixture to about 40° C. to about 50° C.

32. The method as recited in claim 29, wherein the act of humidifying comprises humidifying the gas mixture to a range from about 60% to about 95% relative humidity.

33. The method as recited in claim 29, wherein the act of delivering is controlled by the common controller.

34. An apparatus used in performing live cell analysis, the apparatus comprising:
a stage housing having a recess;
a chamber housing movably disposed within the recess of the stage housing, the chamber housing being adapted to removably receive a specimen plate holding live cells, the chamber housing having a perimeter wall with an interior surface and an exterior surface extending from an upper end to a spaced apart lower end, the perimeter wall bounding a compartment that passes all the way through the chamber housing from the upper end to the lower end, the perimeter wall also having an opening extending between the interior surface and the exterior surface with a transparent window disposed therein;
a microscope disposed below the chamber housing, the microscope being configured to perform high content screening of live cells; and
an optical reader positioned to read an optical identifier on a specimen plate through the window of the chamber housing when a specimen plate has been inserted into the chamber housing.

35. The apparatus as recited in claim 34, further comprising a specimen plate, the specimen plate having a side surface extending between a top surface and an opposing bottom surface, an optical identifier being mounted on the side surface, the top surface having a plurality of wells formed thereon adapted to receive live cells, the specimen plate being at least partially disposed within the compartment of the chamber housing so that the plurality of wells communicate with the compartment of the chamber housing, wherein the microscope is disposed below the bottom surface of the specimen plate, and wherein the optical reader is positioned to read the optical identifier on the specimen plate through the window of the chamber housing.
